(19) United States
(12) Patent Application Publication
(10) Pub. No.: US 2026/0368974 A1
(43) Pub. Date: Nov. 19, 2026

(54) Layer Composition Method, Electronic Device, and Storage Medium

(71) Applicant: Honor Device Co., Ltd., Shenzhen (CN)

(72) Inventors: Junming Zhang, Shenzhen (CN); Wenguang Zhang, Shenzhen (CN); Lifeng Cai, Shenzhen (CN)

(21) Appl. No.: 19/736,457

(22) Filed: Jul. 9, 2026

Related U.S. Application Data
(63) Continuation of application No. PCT/CN2024/071587, filed on Jan. 10, 2024.

(51) Int. Cl. G06T 11/60; G06T 1/20; G06T 3/60

(52) U.S. Cl. CPC G06T 11/60; G06T 1/20; G06T 3/60; G06T 2200/24

(57) ABSTRACT

This disclosure provides a layer composition method, an electronic device, and a storage medium, and relates to the field of terminal technologies, to improve layer composition efficiency, reduce a frame loss problem, and improve user experience. The method is applied to an electronic device, and the method includes: obtaining layer information of to-be-composited layers in a current frame; determining a first detection result based on the layer information of the to-be-composited layers; when the first detection result does not meet a first condition, and first target layers that meet a preset condition exist in the to-be-composited layers, controlling a GPU to composite the first target layers to obtain a first intermediate layer, and controlling an HWC to query a composition manner of the to-be-composited layers.

### CROSS-REFERENCE TO RELATED APPLICATION

This is a continuation of International Patent Application No. PCT/CN2024/071587, filed on Jan. 10, 2024, which is incorporated herein by reference in its entirety.

### TECHNICAL FIELD

This disclosure relates to the field of terminal technologies, and in particular, to a layer composition method, an electronic device, and a storage medium.

### BACKGROUND

Currently, to improve layer composition efficiency and reduce composition pressure of a graphics processing unit (GPU), most electronic devices such as mobile phones are equipped with a hardware composer (HWC). The HWC is mainly configured to help a display composition system SurfaceFlinger (which may be referred to as an SF) perform layer composition, to reduce a composition amount of layer composition to be performed by the SF through the GPU. However, performance of the HWC is limited. Therefore, after receiving a composition request for layers, the HWC first determines, based on a capability of the HWC and a layer parameter, whether the layers are to be composited by the GPU or the HWC, and then after determining a result about who composites the layers, sends a corresponding layer parameter to a corresponding component for composition. A process of determining who composites the layers may be referred to as querying a composition policy.

However, an existing layer composition procedure may cause a frame loss problem, affecting user experience.

### SUMMARY

Embodiments of this disclosure provide a layer composition method, an electronic device, and a storage medium, to improve layer composition efficiency, reduce a frame loss problem, and improve user experience.

To achieve the foregoing objective, the following technical solutions are used in the embodiments of this disclosure.

According to a first aspect, an embodiment of this disclosure provides a layer composition method, applied to an electronic device. The method includes: obtaining layer information of to-be-composited layers in a current frame; determining a first detection result based on the layer information of the to-be-composited layers; when the first detection result does not meet a first condition, and first target layers that meet a preset condition exist in the to-be-composited layers, controlling a GPU to composite the first target layers to obtain a first intermediate layer, and controlling an HWC to query a composition manner of the to-be-composited layers, where a composition manner of the first target layers that meet the preset condition is GPU composition, and the preset condition includes any one or more of the following: a layer attribute parameter or a display parameter of a layer changes; a layer is a newly added layer, a layer attribute parameter includes a first mark, and the first mark is used to indicate to use the GPU for composition; a layer is a newly added layer, and a buffer size of the layer is greater than a preset size; a composition manner of a layer in a previous frame is GPU composition, and a position of the layer changes or a visible area of the layer becomes larger; or a position of a layer is rotated 180° compared with that in a previous frame; and when composition manners of all second target layers are HWC composition, controlling the HWC to composite the first intermediate layer and the second target layers to obtain an image of the current frame, where the second target layers are to-be-composited layers other than the first target layers in the to-be-composited layers.

Based on the technical solution provided in this disclosure, if all to-be-composited layers of the current frame do not meet a parallel condition (a hash value of the current frame is different from a hash value of the previous frame), when a special layer that meets the preset condition exists, GPU composition and composition policy query may be performed in parallel, to reduce time required for layer composition, and reduce a frame loss problem caused by excessively long layer composition time, so that a display effect of a dynamic picture is smoother, and user experience is improved.

In a possible design manner of the first aspect, the determining a first detection result based on the layer information of the to-be-composited layers includes: calculating, by the electronic device, a hash value of the current frame based on the layer information of the to-be-composited layers; and when the hash value of the current frame is the same as a hash value of the previous frame, determining that the first detection result meets the first condition; or when the hash value of the current frame is different from a hash value of the previous frame, determining that the first detection result does not meet the first condition.

Based on the foregoing design manner, whether the first detection result meets the first condition may be determined through hash comparison, and then whether GPU composition and composition policy query can be performed in parallel may be determined.

In a possible design manner of the first aspect, after the controlling a GPU to composite the first target layers to obtain a first intermediate layer, and controlling an HWC to query a composition manner of the to-be-composited layers, the method further includes: when a third target layer whose composition manner is GPU composition exists in the second target layers, controlling the GPU to composite the third target layer with the first intermediate layer to obtain an updated first intermediate layer, where the third target layer and the first target layer are different to-be-composited layers; and controlling the HWC to composite the updated first intermediate layer and a to-be-composited layer other than the third target layer in the second target layers to obtain the image of the current frame.

Based on the foregoing design manner, after GPU composition and composition policy query are performed in parallel, a layer (for example, the third target layer) that needs to be composited by the GPU but that has not been composited by the GPU may be further composited with an intermediate layer (for example, the first intermediate layer) obtained after GPU composition and composition policy query are performed in parallel, to obtain an updated intermediate layer. In this way, a to-be-composited layer that cannot be composited by the HWC can be successfully composited by the GPU, so that layer composition efficiency is improved, and it is ensured that final composition and send-for-display can be successfully completed by the HWC.

In a possible design manner of the first aspect, the method further includes: when the first detection result does not meet the first condition, and no first target layer exists in the to-be-composited layers, if fourth target layers exist in the to-be-composited layers, controlling the GPU to composite the fourth target layers to obtain a second intermediate layer, and controlling the HWC to query the composition manner of the to-be-composited layers, where a composition manner of the fourth target layers is GPU composition, and a composition manner of the fourth target layers in the previous frame is GPU composition; and when composition manners of all fifth target layers are HWC composition, controlling the HWC to composite the second intermediate layer and the fifth target layers to obtain the image of the current frame, where the fifth target layers are to-be-composited layers other than the fourth target layers in the to-be-composited layers.

Based on the foregoing design manner, when the to-be-composited layers of the current frame do not meet the first condition (the hash value of the current frame is different from the hash value of the previous frame), and no special layer that meets the preset condition exists, if a special layer on which GPU composition is performed in the previous frame exists, the electronic device may perform GPU composition and composition policy query in parallel, to reduce time required for layer composition, and reduce a frame loss problem caused by excessively long layer composition time, so that a display effect of a dynamic picture is smoother, and user experience is improved.

In a possible design manner of the first aspect, after the controlling the GPU to composite the fourth target layers to obtain a second intermediate layer, and controlling the HWC to query the composition manner of the to-be-composited layers, the method further includes: when a sixth target layer whose composition manner is GPU composition exists in the fifth target layers, controlling the GPU to composite the sixth target layer with the second intermediate layer to obtain an updated second intermediate layer, where the sixth target layer and the fourth target layer are different to-be-composited layers; and controlling the HWC to composite the updated second intermediate layer and a to-be-composited layer other than the sixth target layer in the fifth target layers to obtain the image of the current frame.

Based on the foregoing design manner, after GPU composition and composition policy query are performed in parallel, a layer (for example, the third target layer) that needs to be composited by the GPU but that has not been composited by the GPU may be further composited with an intermediate layer (for example, the first intermediate layer) obtained after GPU composition and composition policy query are performed in parallel, to obtain an updated intermediate layer. In this way, a to-be-composited layer that cannot be composited by the HWC can be successfully composited by the GPU, so that layer composition efficiency is improved, and it is ensured that final composition and send-for-display can be successfully completed by the HWC.

In a possible design manner of the first aspect, the layer information includes an identifier of a buffer of the layer, a layer attribute parameter, and a display parameter; the layer attribute parameter includes any one or more of the following: a blur parameter, transparency, a position, a size, a name, a type, and visibility; and the display parameter includes any one or more of the following: a color, transparency, a blending mode, a depth sorting, a clipping parameter, and an occlusion parameter.

Based on the foregoing design manner, the electronic device can determine, by using rich layer information, whether a to-be-composited layer can be composited by the GPU or the HWC, and can accurately determine whether the first detection result meets the first condition, so as to determine whether GPU composition and composition policy query can be performed in parallel, thereby ensuring successful layer composition.

In a possible design manner of the first aspect, the newly added layer is a layer that does not exist in the previous frame.

The newly added layer increases a quantity of to-be-composited layers, and it is more likely to exceed a composition capability of the HWC. Therefore, based on the foregoing design manner, whether a layer is a newly added layer is used as a factor of whether a to-be-composited layer can be directly composited by the GPU, so that a more accurate determining result may be obtained.

In a possible design manner of the first aspect, before the obtaining layer information of to-be-composited layers in a current frame, the method further includes: receiving a first operation of a user, and initiating startup of a first application; and obtaining the layer information of the to-be-composited layers in the current frame in a startup process of the first application.

In an application startup process, there is a relatively great change between two adjacent frames. Therefore, based on existing layer composition logic, layer composition duration is excessively long, and a frame loss problem is caused. Based on the foregoing design manner, in an application scenario such as an application startup process, using the layer composition method provided in this disclosure can improve layer composition efficiency and reduce a frame loss problem, so that the application startup process is smoother, and user experience is improved.

According to a second aspect, an embodiment of this disclosure further provides a layer composition apparatus, and the apparatus may be used in an electronic device. A function of the apparatus may be implemented by using hardware, or may be implemented by executing corresponding software by hardware. The hardware or the software includes one or more modules corresponding to the function, for example, an obtaining module, a determining module, and a control module.

The obtaining module is configured to obtain layer information of to-be-composited layers in a current frame. The determining module is configured to determine a first detection result based on the layer information of the to-be-composited layers that is obtained by the obtaining module. The control module is configured to: when the first detection result determined by the determining module does not meet a first condition, and first target layers that meet a preset condition exist in the to-be-composited layers obtained by the obtaining module, control a GPU to composite the first target layers to obtain a first intermediate layer, and control an HWC to query a composition manner of the to-be-composited layers, where a composition manner of the first target layers that meet the preset condition is GPU composition, and the preset condition includes any one or more of the following: a layer attribute parameter or a display parameter of a layer changes; a layer is a newly added layer, a layer attribute parameter includes a first mark, and the first mark is used to indicate to use the GPU for composition; a layer is a newly added layer, and a buffer size of the layer is greater than a preset size; a composition manner of a layer in a previous frame is GPU composition, and a position of the layer changes or a visible area of the layer becomes larger; or a position of a layer is rotated 180° compared with that in a previous frame. The control module is further configured to: when composition manners of all second target layers are HWC composition, control the HWC to composite the first intermediate layer and the second target layers to obtain an image of the current frame, where the second target layers are to-be-composited layers other than the first target layers in the to-be-composited layers.

According to a third aspect, this disclosure provides an electronic device. The electronic device includes a display, a memory, and one or more processors. The display and the memory are coupled to the processor. The memory stores computer program code, the computer program code includes computer instructions, and when the computer instructions are executed by the processor, the electronic device is enabled to perform the layer composition method according to the first aspect and any possible design manner of the first aspect.

According to a fourth aspect, this disclosure provides a computer-readable storage medium. The computer-readable storage medium includes computer instructions. When the computer instructions are run on an electronic device, the electronic device is enabled to perform the layer composition method according to the first aspect and any possible design manner of the first aspect.

According to a fifth aspect, this disclosure provides a computer program product. When the computer program product runs on an electronic device, the electronic device is enabled to perform the layer composition method according to the first aspect and any possible design manner of the first aspect.

It may be understood that, for beneficial effects that can be achieved by the technical solutions provided in the second aspect to the fifth aspect provided above, refer to the beneficial effects in the first aspect and any possible design manner of the first aspect. Details are not described herein again.

### BRIEF DESCRIPTION OF DRAWINGS

FIG. 1 is a schematic diagram of a home screen according to an embodiment of this disclosure;

FIG. 2A to FIG. 2D are a schematic diagram of layer disassembly of a home screen according to an embodiment of this disclosure;

FIG. 3 is a schematic flowchart of layer composition according to a related technology;

FIG. 4 is a schematic diagram of performing a display procedure based on a Vsync signal according to a related technology;

FIG. 5A to FIG. 5D are a schematic flowchart of layer composition according to a related technology;

FIG. 6 is a schematic diagram of a principle of a layer composition method according to an embodiment of this disclosure;

FIG. 7 is a schematic diagram of a hardware structure of an electronic device according to an embodiment of this disclosure;

FIG. 8 is a schematic diagram of a software architecture of an electronic device according to an embodiment of this disclosure;

FIG. 9A to FIG. 9E are a schematic flowchart 1 of a layer composition method according to an embodiment of this disclosure;

FIG. 10A and FIG. 10B are a schematic diagram of a user operation scenario according to an embodiment of this disclosure;

FIG. 11A to FIG. 11E are a schematic flowchart 2 of a layer composition method according to an embodiment of this disclosure;

FIG. 12A to FIG. 12F are a schematic flowchart 3 of a layer composition method according to an embodiment of this disclosure;

FIG. 13A and FIG. 13B are a schematic flowchart 4 of a layer composition method according to an embodiment of this disclosure;

FIG. 14 is a schematic diagram of a structure of a layer composition apparatus according to an embodiment of this disclosure;

FIG. 15 is a schematic diagram of a structure of a chip system according to an embodiment of this disclosure; and

FIG. 16 is a schematic diagram of a structure of a computer program product according to an embodiment of this disclosure.

### DESCRIPTION OF EMBODIMENTS

Terms used in the following embodiments of this disclosure are merely intended to describe specific embodiments, but not intended to limit this disclosure. As used in this specification and the claims of this disclosure, singular expressions “one”, “a”, “the”, “foregoing”, and “this” are intended to include plural expressions, unless otherwise clearly specified in the context. It should be further understood that “/” represents a meaning of “or”. For example, “A/B” may represent A or B. The term “and/or” in this specification describes only an association relationship for describing associated objects and represents that three relationships can exist. For example, “A and/or B” can represent the following three cases: Only A exists, both A and B exist, and only B exists.

An “embodiment” in this disclosure means that a specific feature, structure, or characteristic described with reference to the embodiment may be included in at least one embodiment of this disclosure. The term appearing at various positions in the specification does not necessarily refer to a same embodiment, or an independent or alternative embodiment mutually exclusive with another embodiment. A person skilled in the art explicitly and implicitly understands that the described embodiments in this disclosure may be combined with another embodiment.

In the following embodiments of this disclosure, the terms “first” and “second” are used only for description purposes, and cannot be construed as an implication or implication of relative importance or implicit indication of a quantity of indicated technical features. Therefore, features defined with “first” and “second” may explicitly or implicitly include one or more features. In the descriptions of the embodiments of this disclosure, unless otherwise stated, “a plurality of” means two or more.

First, terms in the embodiments of this disclosure are described as follows.
(1) Buffer: The buffer is a memory area used to temporarily store data. The buffer is an important component for temporarily storing data in a computer system, and the buffer is storage space reserved in a memory. The storage space is used to buffer input or output data. Specifically, the buffer may coordinate a speed inconsistency between an input output (IO) device and a central processing unit (CPU). The buffer is set between a low-speed device and a high-speed device, so that a constraint relationship between the low-speed device and the high-speed device can be relieved, data transmission and processing efficiency can be improved, and system performance can be improved. The buffer may be used to store data. Only when a data amount reaches a specific level, a real read/write operation is performed, so that a quantity of read/write times can be reduced, and efficiency can be improved. For example, during image processing, image data may be read into the buffer and then processed, and finally a processing result is written into a disk or a display device.
(2) User interface thread (UI thread): The UI thread is also referred to as a main thread, and is a core thread responsible for processing a user interface (UI). The UI thread is responsible for rendering UI elements including various controls such as a drawing event, and processing user input events such as a screen touch. All these operations are scheduled and controlled by the main thread. Android® specifies that a control in an activity is refreshed by the main thread, and cannot be directly refreshed by another thread.
(3) Render thread: is configured to receive an instruction of a UI thread, and draw, into a frame buffer, a UI component of each layer indicated by the UI thread. A frame is buffered.
(4) Frame: The frame is a single picture of a smallest unit when an electronic device displays a picture. One frame may be understood as one still picture, and displaying a plurality of connected frames quickly and consecutively can form an illusion of object movement. One frame of picture may be obtained by compositing a plurality of layers. Before the electronic device displays a frame of picture, drawing and rendering of each layer in the frame of picture need to be completed first, and then all layers that are drawn and rendered are composited to obtain a final frame of picture for display by the electronic device.
(5) Layer: Each application may correspond to one or more graphical interfaces, and each graphical interface may be referred to as a layer. Each frame of display interface (or referred to as each frame of picture) of an electronic device is usually obtained by compositing a plurality of layers.

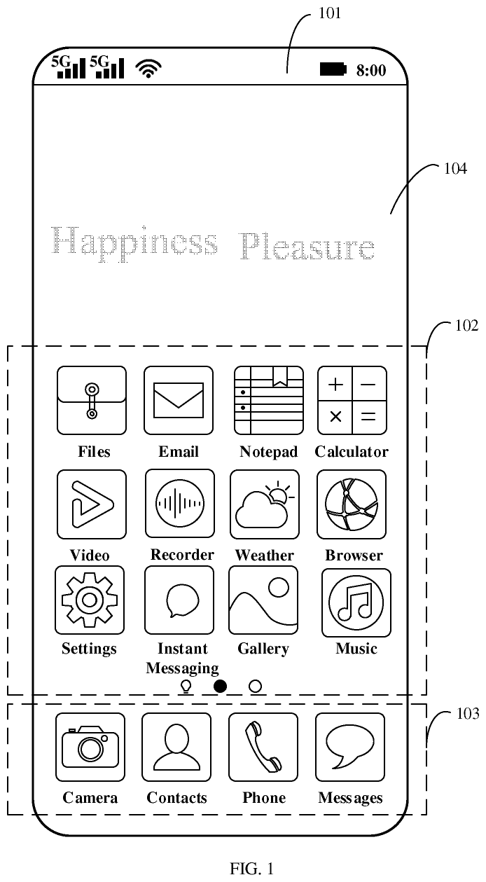

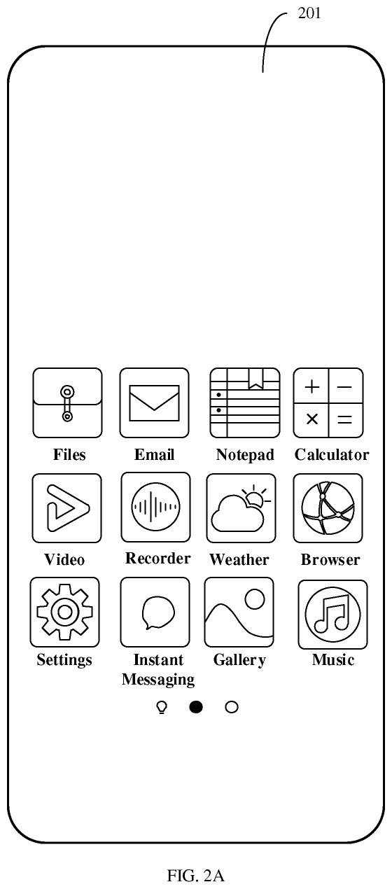

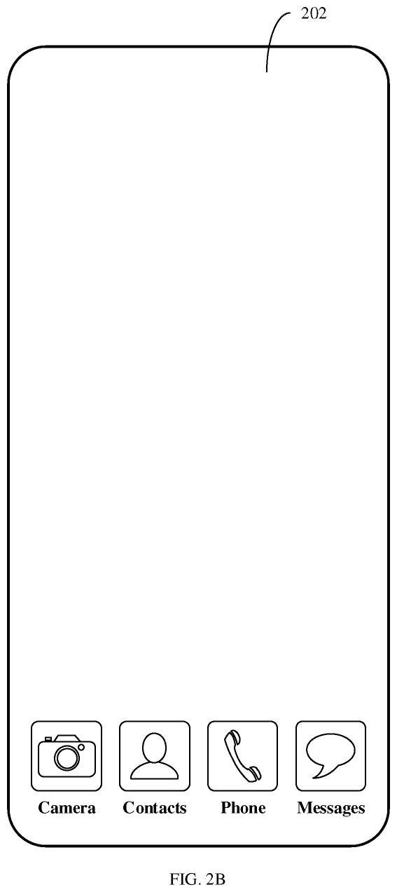

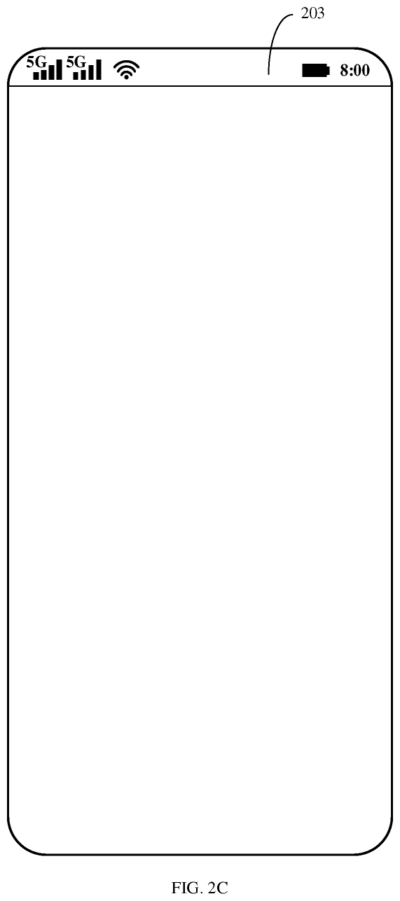

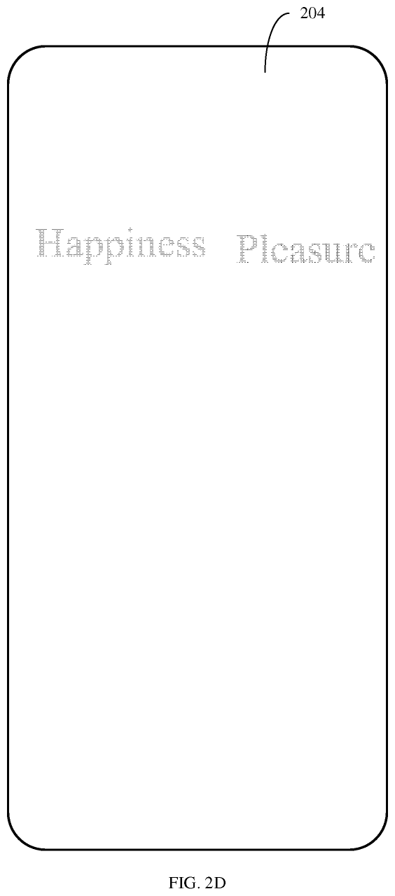

For example, the electronic device is a mobile phone. Referring to FIG. 1, a frame of desktop displayed on the mobile phone may include a status bar 101, an application icon tray 102, a fixed icon bar 103, and a desktop background 104. The application icon tray 102 displays a plurality of application icons, and the plurality of application icons may be switched in response to a slide operation in the application icon tray 102. The desktop shown in FIG. 1 may be split into a plurality of layers shown in FIG. 2A to FIG. 2D. FIG. 2A to FIG. 2D show an example of a layer structure of the desktop. As shown in FIG. 2A to FIG. 2D, the desktop shown in FIG. 1 may include four layers: an interaction layer 201, a fixed icon layer 202, a status bar layer 203, and a background layer 204. The icon layer 201 is a layer at which a control such as an application icon that can be immediately operated and switched by a user on the desktop (for example, the application icon tray 102) is located. The fixed icon layer 202 is a layer at which the fixed icon bar 103 on the desktop that is unavailable for overall content switching in response to a slide operation of the user is located. The status bar layer 203 is a layer at which the status bar 101 on the desktop is located. The background layer 204 is a layer at which the desktop background 104 (for example, a theme or a wallpaper) is located. In some scenarios, if the user performs a slide operation on the application icon tray 102 to switch an application icon displayed in the tray, a desktop application displays a switching animation in a switching process. In a process of playing the switching animation, only the interaction layer 201 changes.

A change of a layer in a display interface may include changes of a layer attribute parameter, layer content, and a display parameter. The layer content is content displayed at the layer, for example, status icons such as a network status, a battery status, a device connection status, a mobile phone setting status, or time at the status bar layer. The layer attribute parameter is a parameter that defines a feature of the layer, and includes a type, a name, visibility, a position, a size, transparency, a blur parameter, and the like of the layer. These parameters determine basic attributes and behavior of the layer, and can be accessed and modified during drawing and rendering. The Display parameter is a parameter for controlling an appearance and an effect of the layer during final display, and includes a color, transparency, a blending mode (for example, pre-multiplied per-pixel (per-pixel) Alpha blending and per-plane (per-plane) Alpha blending), a depth sorting (for example, a sequence of layers on a Z-axis), clipping, occlusion, and the like. These parameters are used to further control and adjust the layer in a rendering process to achieve a required display effect.

(6) Display composition system (SurfaceFlinger (SF)): The SurfaceFlinger is a system service, and this system service is mainly configured to implement functions such as layer creation, control, and management. In a display system of an electronic device, layer composition may be implemented by using the SurfaceFlinger. For example, after an application is started, the SurfaceFlinger may create a layer for the application. In a running process of the electronic device, the SurfaceFlinger may obtain to-be-displayed layers of various applications running on the electronic device, and composite the obtained layers by using a GPU and/or an HWC. In an example, after startup, the application may send a layer creation request to the SurfaceFlinger. After receiving the layer creation request of the application (which may be specifically a UI thread of the application), the SurfaceFlinger creates a corresponding layer for the application, and returns a layer control SurfaceControl pointer of the created layer to the application, so that the application draws and renders the layer. The created layer has a corresponding layer attribute parameter and a corresponding display parameter.

(7) Hardware composer (HWC): The HWC (hwcomposer) is a hardware abstraction layer (HAL) module that performs layer composition and display in Android®. An implementation of the HWC is device-specific and is usually completed by an electronic device manufacturer (OEM), to provide hardware support for a SurfaceFlinger. A function of the HWC is to help the display composition system SurfaceFlinger (which may be referred to as an SF composer) composite layers, thereby reducing a composition amount of layer composition performed by the SF composer by using a GPU. The HWC can abstract objects such as an overlay layer and a 2D blitter to compose an image, and communicate with dedicated layer composition hardware to composite layers. For example, the layer composition hardware used when the HWC performs layer composition may include hardware such as a digital signal processor (DSP), a vision processing unit (VPU), and a display processing unit (DPU).

Generally, the HWC may support the following capabilities: At least four overlay layers: a status bar (displaying content such as a network status), a system bar (displaying content such as a home button), an application interface (displaying content of an application running in the foreground), and a wallpaper or background, are supported. The overlay layer may be larger than a display, for example, a wallpaper size may be greater than a display size. Pre-multiplied per-pixel Alpha blending (pre-multiplied per-pixel Alpha blending means that a pre-multiplication operation has been performed on a color value of each pixel in a layer by multiplying by a corresponding Alpha value before Alpha blending) and per-plane (per-plane) Alpha blending (per-plane Alpha blending is used to perform transparency blending between a plurality of layers, so that transparency of a layer can affect transparency of all layers below the layer. During per-plane Alpha blending, transparency of each pixel is calculated based on a plane on which the pixel is located rather than based on a single pixel) are supported at the same time. To support protected content, a hardware path for protected video playback needs to be provided.

In an electronic device, a SurfaceFlinger may use an open graphics library embedded system (Open Graphics Library Embedded Systems, OpenGL ES) to composite layers. This needs to occupy and consume GPU resources. However, most GPUs are not optimized for layer composition. When the SurfaceFlinger receives a layer composition request of an application and composite layers by using the GPU, GPU resources are occupied, and the application or another application cannot obtain enough GPU resources to perform another task such as layer rendering. In this case, performance of the application may be degraded, especially a graphics-intensive application. To resolve this problem, in the current electronic device, some layers may be composited by an HWC by using a dedicated hardware module, to reduce composition pressure of the GPU. In this way, the application in the electronic device can better perform self-rendering (for example, rendering a layer in a display image required by the application) by using the GPU, thereby improving graphics performance and user experience.

Specifically, capabilities of electronic devices vary greatly, and it is difficult to directly indicate, by using a parameter of an application programming interface (API), a type and a quantity of layers whose composition is supported by a hardware device in a display device, whether rotation and blending mode operations can be performed on the layer in a composition process, a limitation on layer positioning and hardware composition, and the like. Therefore, a process of performing layer composition by using the HWC in the electronic device is as follows:

First, after receiving a drawing request for a frame of image, the SurfaceFlinger provides information about all layers of the frame of image for the HWC, so that the HWC determines, based on a hardware capability of the HWC, how to process the layers.

Specifically, after receiving the information about all the layers of the frame of image, the HWC determines, based on the capability of the HWC, whether each layer is composited by using the GPU or the HWC. For example, after receiving information about a plurality of layers of a frame of image, the HWC performs a phase of querying a composition policy, and sends a queried composition policy to the SurfaceFlinger. The composition policy includes a composition manner of each layer, for example, whether each layer is composited by using the GPU or the HWC.

Then, the SurfaceFlinger composites, according to the composition policy by using the GPU, all layers that need to be composited by the GPU into an output buffer. Then, the SurfaceFlinger may deliver the output buffer and other layers that need to be composited by the HWC to the HWC to complete final overlay composition and send-for-display.

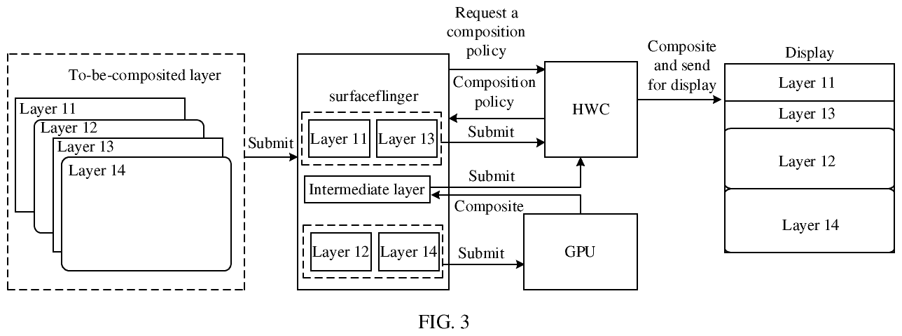

FIG. 3 is a schematic flowchart of an example of layer processing. For example, an electronic device is a mobile phone. As shown in FIG. 3, it is assumed that layers that need to be composited in a frame of image that currently needs to be displayed on the mobile phone may include a layer 11, a layer 12, a layer 13, and a layer 14. After being drawn and rendered by an application, these layers may be transferred to a SurfaceFlinger for layer composition. After the SurfaceFlinger collects these layers, an HWC may first query a composition policy, to determine a composition manner of each to-be-composited layer. In some embodiments, the HWC may determine a composition manner of a layer with a radius in to-be-composited layers as GPU composition, and determine a composition manner of a remaining layer as HWC composition. Certainly, for how to specifically obtain the composition manner of each to-be-composited layer, for example, the composition policy, the HWC further needs to perform determining by using any feasible rule with reference to a capability of the HWC and parameters such as content and a size of each to-be-composited layer. This is not specifically limited in this disclosure.

Based on the foregoing composition policy, for example, composition manners of the layer 12 and the layer 14 may be set to a GPU composition manner, and composition manners of the layer 11 and the layer 13 may be set to an HWC composition manner.

After the composition manner of each to-be-composited layer is determined, the SurfaceFlinger may make the GPU composite the layer 12 and the layer 14 whose compositions manners are the GPU composition manner, and make the HWC composite the layer 11 and the layer 13 whose compositions manners are the HWC composition manner. After compositing the layer 12 and the layer 14, the GPU submits an intermediate layer obtained through composition to the SurfaceFlinger in a form of an output buffer.

Then, the SurfaceFlinger delivers the intermediate layer composited by the GPU to the HWC, and after compositing a final target interface, the HWC transfers the target interface to a display for display.

(8) Vertical synchronization (Vsync) signal: Displaying one line of pixels by a display is referred to as line scan, and displaying all lines of pixels by the display is referred to as field scan. A physical signal at which the display starts to scan a field is referred to as the vertical synchronization signal. After completing scanning one field, the display may display one frame of image data, for example, the display may display one frame of image data in a period of one Vsync signal. A quantity of fields that can be refreshed by the display per second, for example, a quantity of frames of image data that can be displayed by the display per second determines a quantity of Vsync signals that need to be generated by an electronic device per second. To avoid display freezing and improve visual performance of graphics, a display system in the electronic device synchronizes procedures (including drawing, rendering, composition, and sending for display) of image display by using a Vsync signal. For a frame of image, when the electronic device displays the frame of image based on a Vsync signal, an application rendering procedure needs to be performed in an N^{th} Vsync period, a layer composition procedure needs to be performed in an (N+1)^{th} Vsync period, and a hardware send-for-display procedure needs to be performed in an (N+2)^{th} Vsync period. For example, it takes at least two Vsync periods from application rendering to hardware send-for-display of a frame of image.

Generally, the Vsync signal may trigger the application drawing and rendering procedure, the layer composition procedure, and the hardware send-for-display procedure at the same time.

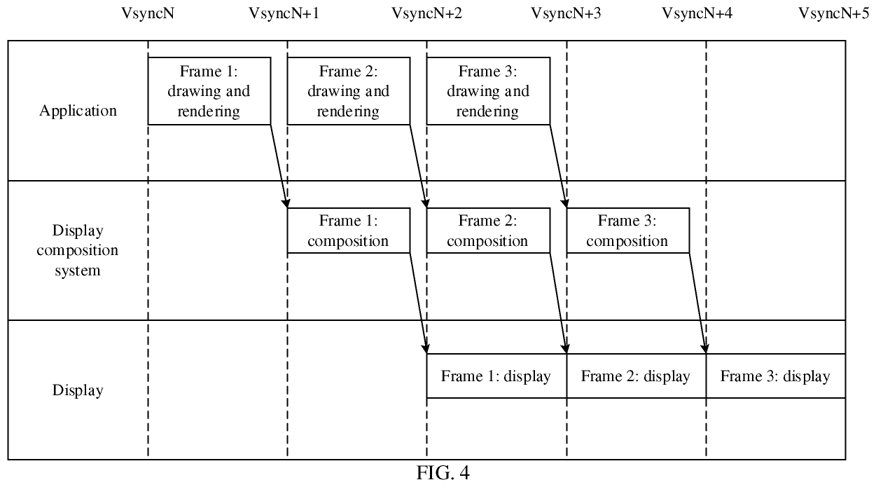

For example, FIG. 4 is a schematic diagram of performing a display procedure based on a Vsync signal according to a related technology. As shown in FIG. 4, for three frames of pictures: a frame 1, a frame 2, and a frame 3, that need to be displayed by an application in an electronic device, the application may start to draw and render the frame 1 when an N^{th} Vsync signal VsyncN is received; start to draw and render the frame 2 when an (N+1)^{th} Vsync signal VsyncN+1 is received; and start to draw and render the frame 3 when an (N+2)^{th} Vsync signal VsyncN+2 is received. A drawing and rendering procedure does not exceed one Vsync period, for example, does not exceed a time interval between two adjacent Vsync signals.

A SurfaceFlinger display composition system may start to perform layer composition on the frame 1 when the (N+1)^{th} Vsync signal VsyncN+1 is received; start to perform layer composition on the frame 2 when the (N+2)^{th} Vsync signal VsyncN+2 is received; and start to perform layer composition on the frame 3 when the (N+3)^{th} Vsync signal VsyncN+3 is received. A layer composition procedure does not exceed one Vsync period, for example, does not exceed a time interval between two adjacent Vsync signals.

The SurfaceFlinger display composition system may send the frame 1 for display when the (N+2)^{th} Vsync signal VsyncN+2 is received, so that a display starts displaying; send the frame 2 for display when the (N+3)^{th} Vsync signal VsyncN+3 is received, so that the display starts displaying; and send the frame 3 for display when an (N+4)^{th} Vsync signal VsyncN+4 is received, so that the display starts displaying. A display procedure of each frame lasts for one Vsync period, for example, one frame of image is displayed within a time interval between every two adjacent Vsync signals after the display starts image displaying.

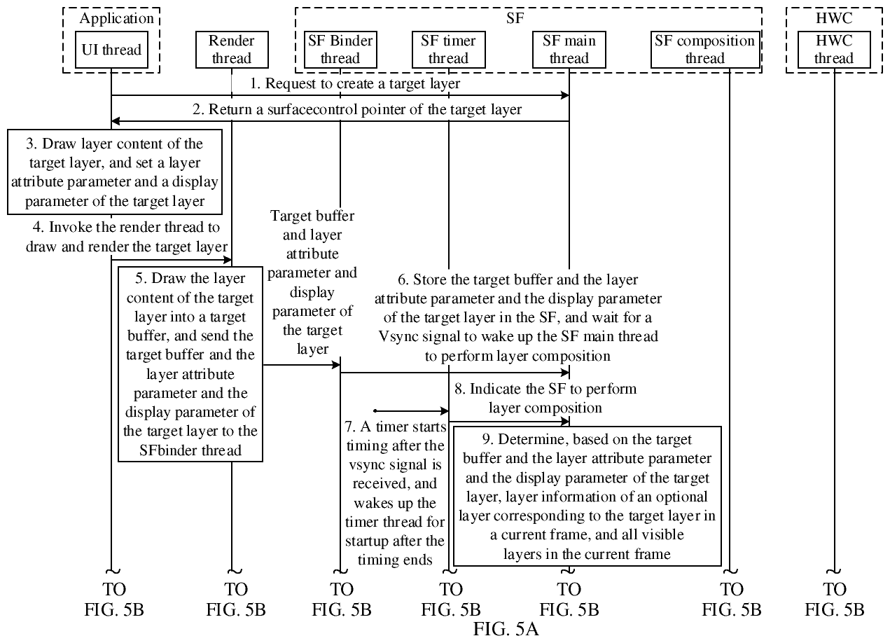

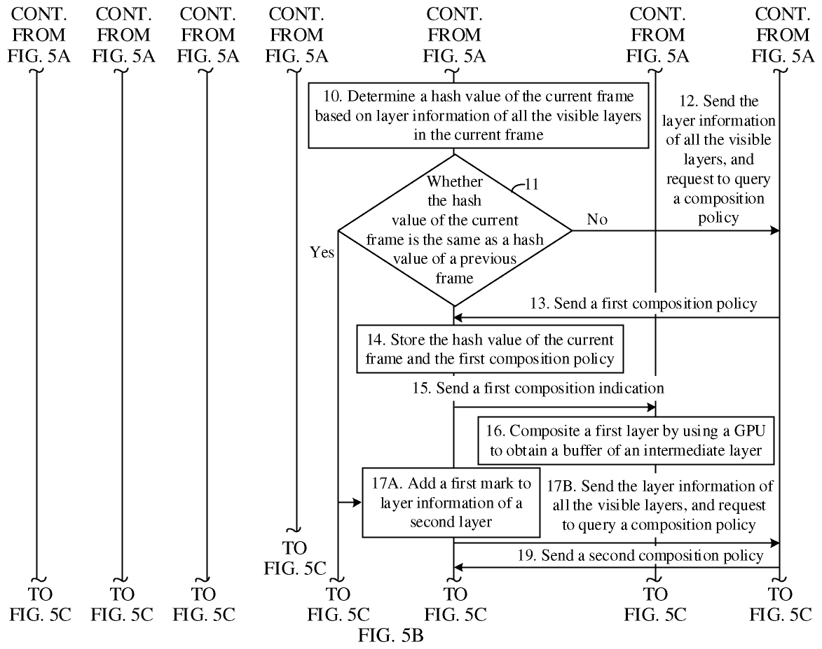

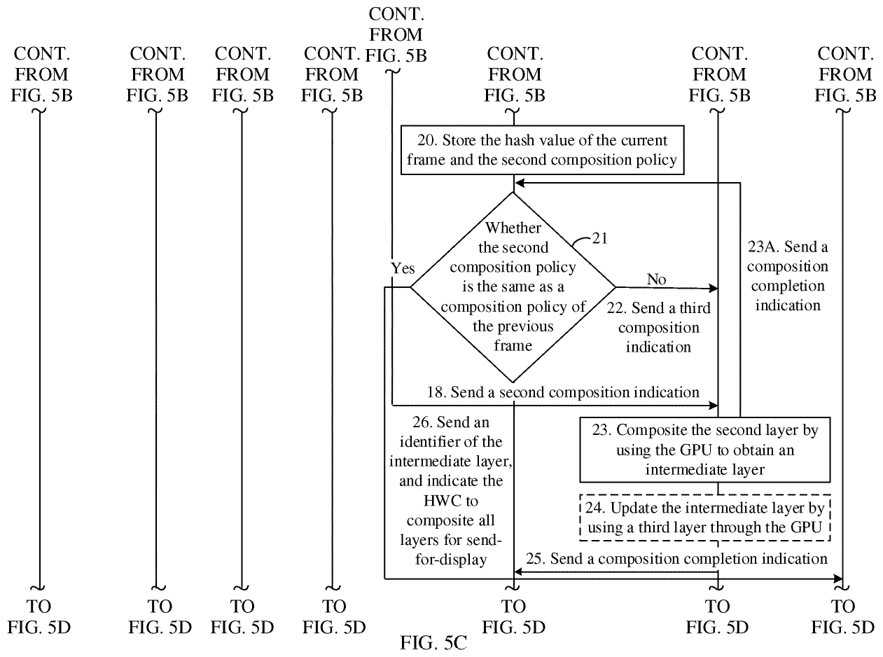

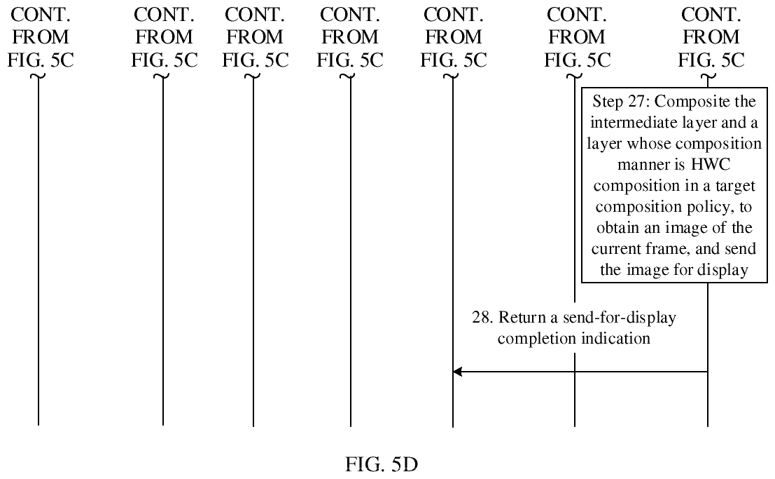

Currently, for an electronic device that has a display function, layer composition efficiency is to be improved, and layer composition pressure of a GPU is to be reduced. For example, the electronic device is a mobile phone. Referring to FIG. 5A to FIG. 5D, a layer composition procedure in the existing electronic device may include the following steps.

Step 1: After receiving a layer drawing instruction, a user interface (UI) thread of an application sends a layer creation request for requesting to create a target layer to a SurfaceFlinger main thread (for example, an SF main thread). The target layer may be one layer, or may be a plurality of layers.

Step 2: After receiving the layer creation request from the UI thread, the SF main thread returns a SurfaceControl pointer of the target layer to the UI thread. If the target layer requested to be created by the layer creation request has not been created before, after receiving the layer creation request, the SF main thread first creates the layer, and then returns the SurfaceControl pointer of the target layer to the UI thread.

Step 3: After receiving the SurfaceControl pointer, the UI thread may draw content of the target layer in a corresponding memory area by using the SurfaceControl pointer, and set a layer attribute parameter and a display parameter of the target layer.

Step 4: The UI thread invokes a render thread to draw and render the target layer. Specifically, the UI thread may send, to the render thread, an address pointer of the memory area in which the layer content, the layer attribute parameter, and the display parameter of the target layer are stored.

Step 5: The render thread draws the layer content of the target layer into a target buffer, and sends the target buffer and the layer attribute parameter and the display parameter of the target layer to an SF binder thread.

Step 6: After receiving the target buffer (which may be specifically a pointer of the target buffer) and the layer attribute parameter and the display parameter of the target layer, the SF binder thread stores the target buffer and the layer attribute parameter and the display parameter of the target layer in an SF, to wait for a Vsync signal (which may be referred to as a Vsync-SF signal) to wake up the SF main thread to perform layer composition.

Step 7: A timer starts timing after the Vsync signal is received, and wakes up a timer thread for startup after the timing ends.

Step 8: After being started, the timer thread sends a start indication to the SF main thread, to indicate the SF main thread to start layer composition.

Step 9: After receiving the start indication, the SF main thread may determine, based on the target buffer and the layer attribute parameter and the display parameter of the target layer, layer information of a corresponding layer in all layers in a current frame, and all visible layers in the current frame.

The layer information includes a layer attribute parameter, a display parameter, and a handle of a buffer to which the layer belongs.

Specifically, the visible layer is a layer that needs to be presented on a display finally. Visibility in a layer attribute parameter of the visible layer is “visible”. Certainly, in practice, “visible” may be a specific value.

Step 10: The SF main thread generates a hash value of the current frame by using layer information of each visible layer in the current frame.

Step 11: The SF main thread determines whether the hash value of the current frame is the same as a hash value of a previous frame.

If the hash value of the current frame is different from the hash value of the previous frame, it may be considered that there is a change between a layer that needs to be displayed in the current frame and a layer that needs to be displayed in the previous frame. In this case, composition policy query and GPU composition are performed in series. In this case, step 12 is performed after step 11. Then, step 13, step 14, step 15, and step 16 are sequentially performed.

If the hash value of the current frame is the same as the hash value of the previous frame, it may be considered that there is no change between a layer that needs to be displayed in the current frame and a layer that needs to be displayed in the previous frame. In this case, composition policy query and GPU composition may be performed in parallel, for example, step 17 (including step 17A and step 17B) and step 18 simultaneously start to be performed.

Step 12: The SF main thread sends layer information of all the visible layers to an HWC thread, and requests to query a composition policy.
Step 13: The HWC thread determines composition manners of all the visible layers, for example, a first composition policy, based on a capability of the HWC thread and the layer information of all the visible layers, and sends the first composition policy to the SF main thread.
Step 14: The SF main thread stores the hash value of the current frame and the first composition policy.

In this way, it can be convenient for the SF main thread to perform hash comparison between two frames when a layer in a next frame is composited, to determine a subsequent layer composition procedure.
Step 15: The SF main thread sends a first composition indication to an SF composition thread.

The first GPU composition indication carries layer information of a first layer whose composition manner is GPU composition in the first composition policy. The first composition indication is used to indicate to place an intermediate layer composited from the first layer into an intermediate buffer.

The intermediate buffer may be selected by the SF main thread from a buffer queue.

Based on this, the SF composition thread composites the first layer by using a GPU, and the composited intermediate layer exists in the intermediate buffer.

Step 16: The SF composition thread composites the first layer by using the GPU to obtain the intermediate layer. Specifically, the intermediate buffer in which layer content of the intermediate layer exists may be obtained.

Step 26 is performed after step 16.

Step 17A: The SF main thread adds a first mark to layer information of a second layer. The first mark is used to indicate to use GPU composition.

Step 17B: The SF main thread sends layer information of all the visible layers to an HWC thread, and requests to query a composition policy.

Step 19 is performed after step 17.

Step 18: The SF main thread sends a second composition indication to an SF composition thread.

The second GPU composition indication carries layer information of a second layer whose composition manner is GPU composition in a composition policy of the previous frame in all the visible layers, and the second composition indication is used to indicate to place an intermediate layer composited from the second layer in an intermediate buffer.

Step 23 is performed after step 18.

Step 19: The HWC thread determines, based on a capability of the HWC thread and the layer information of all the visible layers when composition manners of some visible layers are marked as GPU composition, a composition manner of another layer whose composition manner is marked as GPU composition, to obtain a second composition policy, and sends the second composition policy to the SF main thread.

Step 20 is performed after step 19.

Step 20: The SF main thread stores the hash value of the current frame and the second composition policy.

Step 21 is performed after step 20.

Step 21: The SF main thread determines whether the second composition policy is the same as the composition policy of the previous frame.

If it is determined that the second composition policy is the same as the composition policy of the previous frame, it indicates that all layers that need to be composited by the GPU in all the layers in the current frame have been sent to the SF composition thread for composition. In this case, the SF main thread may determine that all layers that need to be composited by the GPU have been composited, and may subsequently indicate an HWC to perform final composition, for example, perform step 26.

If it is determined that the second composition policy is different from the composition policy of the previous frame of image, it indicates that in addition to the second layer, a third layer that needs to be composited by the GPU may further exist in all the layers in the current frame. In this case, the SF main thread may send layer information of the third layer to the SF composition thread for composition, for example, perform step 22.

Step 22: The SF main thread sends a third composition indication to the SF composition thread.

The third composition indication carries the layer information of the third layer other than the second layer in layers whose composition manners are GPU composition in the second composition policy, and the third composition indication is used to indicate to composite the third layer with the intermediate layer in the intermediate buffer.

Step 25 is performed after step 22.

Step 23: The SF composition thread composites the second layer by using the GPU to obtain the intermediate layer. Specifically, a buffer of the intermediate layer may be obtained.

Step 23A is performed after step 23.

Step 23A: The SF composition thread sends a composition completion indication to the SF main thread.

The composition completion indication indicates that composition of the intermediate layer is completed.

Step 21 is performed after step 23A.

In practice, according to a specific synchronization method, time consumed by the HWC for returning the composition policy to the SF main thread may be the same as time consumed by the SF composition thread for obtaining the intermediate layer by using GPU composition and returning the intermediate layer to the SF main thread. For example, step 23A and step 19 (or step 20) are completed at the same time. Alternatively, after either of step 19 or step 23A is completed, a subsequent procedure is performed only after the other step is completed. In this way, step 21 can be performed after step 19 and step 23A, to ensure smooth implementation of an entire layer composition procedure.

Step 24: The SF composition thread updates the intermediate layer by using the third layer through the GPU.

Specifically, the intermediate layer in the intermediate buffer may be updated.

The intermediate layer updated in step 24 may be specifically the intermediate layer obtained in step 23.

Step 25 is performed after step 24.

Step 25: The SF composition thread sends a composition completion indication to the SF main thread.

Step 26: The SF main thread sends an identifier of the intermediate layer to the HWC thread, and indicates the HWC to composite all the layers in the current frame for send-for-display.

In step 25, there are three cases of the composition completion indication obtained by the SF main thread. In a first case, when step 25 is performed after step 16 is completed, the SF composition thread sends the composition completion indication to the SF main thread. In a second case, after step 23A is completed, the SF composition thread sends the composition completion indication to the SF main thread. In a third case, when step 25 is performed after step 24 is completed, the SF composition thread sends the composition completion indication to the SF main thread.

The identifier of the intermediate layer may be specifically an identifier of the intermediate buffer.

Step 27: The HWC thread composites the intermediate layer and a layer whose composition manner is HWC composition in a target composition policy, to obtain an image of the current frame, and sends the image for display.

The target composition policy may be the first composition policy or the second composition policy.

Step 28: After completing send-for-display, the HWC thread returns a send-for-display completion indication to the SF main thread, so that the SF determines that composition of a layer in the next frame can be performed.

It can be learned from the entire steps of the foregoing layer composition that, in some dynamic picture display scenarios such as application startup or exit, or volume bar or notification message pop-up, the electronic device is likely to encounter, in a display process, a case in which there is a relatively great change (for example, a change of parameters such as a radius, transparency, and a blur degree) between layers in two adjacent frames of images. However, based on existing layer composition logic shown in FIG. 5A to FIG. 5D, in a process of compositing layers in the frames of images, the SF determines that composition policy query and GPU composition need to be performed in series. For example, in this case, in an entire layer composition process, a composition policy needs to be first queried by using the HWC to obtain a composition manner of each to-be-composited layer. Then, some to-be-composited layers are composited by using the GPU. Finally, a composition result of the GPU and a remaining to-be-composited layer are composited by using the HWC. In the entire layer composition process, only after GPU composition is completed, the HWC can composite the composition result of the GPU and the remaining layer, resulting in low layer composition efficiency and flexibility. Therefore, layer composition and send-for-display may not be completed in a display period of one frame of image, causing frame freezing and loss, and affecting user experience.

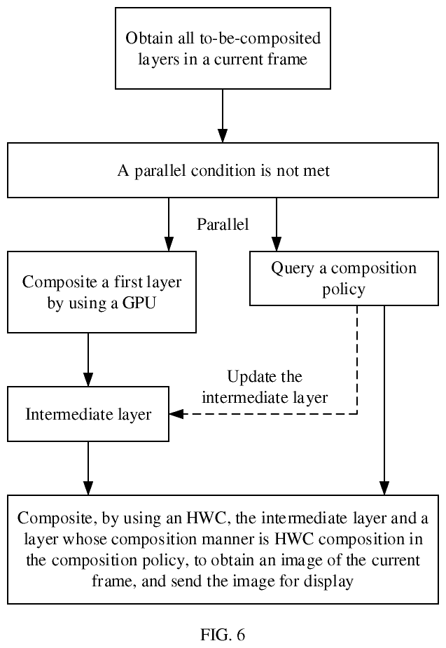

For the foregoing problem, an embodiment of this disclosure provides a method for determining a cause of a frame loss fault, applied to an electronic device. In this technical solution, referring to FIG. 6, after determining all to-be-composited layers in a current frame, the electronic device first determines whether all the to-be-composited layers in the current frame meet a parallel condition. Specifically, the electronic device may determine a hash value of the current frame based on layer information of all the to-be-composited layers. The layer information may include a layer attribute parameter, a display parameter, and an identifier of a buffer corresponding to the layer. When the hash value of the current frame is different from a hash value of a previous frame, it is determined that all the to-be-composited layers in the current frame do not meet the parallel condition. When the hash value of the current frame is the same as a hash value of a previous frame, it is determined that all the to-be-composited layers of the current frame meet the parallel condition.

When all the to-be-composited layers of the current frame do not meet the parallel condition, to improve layer composition efficiency, the electronic device makes a GPU composite a first layer that meets a preset condition in all the to-be-composited layers, and requests an HWC to query a composition policy for another layer, to obtain a composition policy of the current frame. The preset condition includes any one or more of the following: A layer attribute parameter or a display parameter of a layer changes; a layer is a newly added layer, a layer attribute parameter includes a first mark, and the first mark is used to indicate to forcibly use the GPU for composition; a layer is a newly added layer, and a buffer size of the layer is greater than a preset size (for example, 2160px*2160px); a composition manner of a layer in the previous frame is GPU composition, and a position parameter of the layer changes or a visible area of the layer becomes larger; or a position parameter of a layer is rotated 180° compared with that in the previous frame. Certainly, in practice, the preset condition may alternatively be any other feasible condition, and may be specifically determined according to experience of a designer of a mobile phone vendor. This is not specifically limited in this disclosure.

The composition policy of the current frame includes composition manners of all the to-be-composited layers, and a composition manner of the first layer is GPU composition.

Then, after the first layer is composited by using the GPU, an intermediate layer obtained through composition may be provided for the HWC.

After the composition policy of the current frame is obtained by using the HWC, if a second layer other than the first layer further exists in layers whose composition manners are GPU composition, the electronic device further makes the GPU composite the second layer, to update the intermediate layer, and provides an updated intermediate layer for the HWC.

Finally, the electronic device may use the HWC to composite the intermediate layer and a to-be-composited layer whose composition manner is indicated as HWC composition by the composition policy of the current frame, to obtain an image of the current frame, and send the image for display.

In the technical solution provided in this disclosure, when the hash value of the current frame is different from the hash value of the previous frame, GPU composition and composition policy query may be performed in parallel, to reduce time required for layer composition, and reduce a frame loss problem caused by excessively long layer composition time, so that a display effect of a dynamic picture is smoother, and user experience is improved.

The technical solutions provided in embodiments of this disclosure are described below in detail with reference to the accompanying drawings.

The technical solutions provided in this disclosure may be applied to an electronic device that has an animation display function. In some embodiments, the electronic device may be a mobile phone, a tablet computer, a handheld computer, a personal computer (PC), an ultra-mobile personal computer (UMPC), a netbook, a cellular phone, a personal digital assistant (PDA), an augmented reality (AR) device, a virtual reality (VR) device, an artificial intelligence (AI) device, a wearable device, a vehicle-mounted device, a smart home device, a smart city device, and/or the like. A specific type of the electronic device is not specially limited in the embodiments of this disclosure.

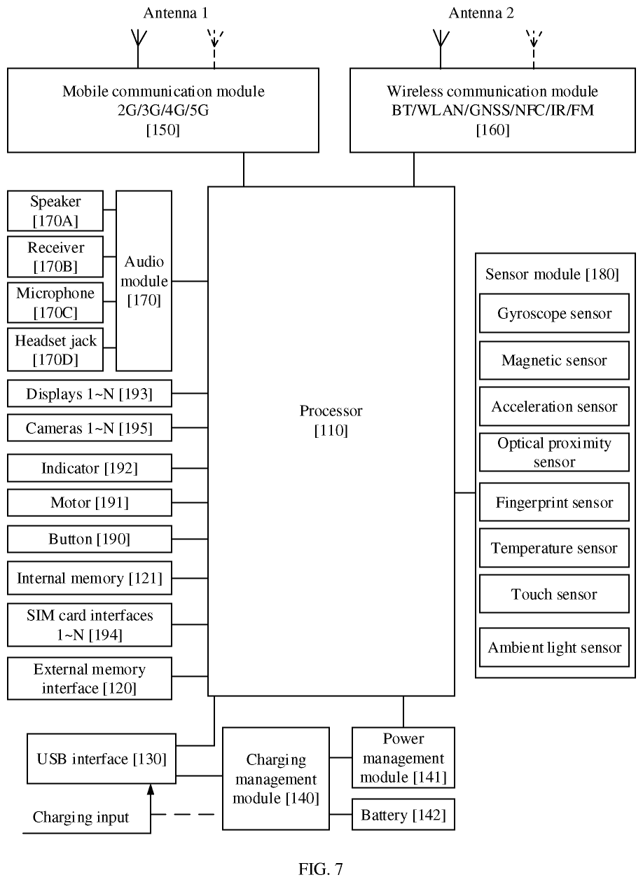

For example, the electronic device is a mobile phone. FIG. 7 is a schematic diagram of a structure of an electronic device according to an embodiment of this disclosure.

As shown in FIG. 7, the electronic device may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a display 193, a subscriber identity module (subscriber identification module, SIM) card interface 194, a camera 195, and the like. The sensor module 180 may include a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

The processor 110 may include one or more processing units. For example, the processor 110 may include an application processor (AP), a modem processor, a graphics processing unit (GPU), a display processing unit (DPU), a vision processing unit (VPU), an image signal processor (ISP), a controller, a memory, a video codec, a digital signal processor (DSP), a baseband processor, a neural-network processing unit (NPU), and/or the like. Different processing units may be independent devices, or may be integrated into one or more processors.

The controller may be a nerve center and a command center of the electronic device. The controller may generate an operation control signal based on instruction operation code and a timing signal, to complete control of instruction fetching and instruction execution.

A memory may be further disposed in the processor 110 to store instructions and data. In some embodiments, the memory in the processor 110 is a cache. The memory may store instructions or data just used or cyclically used by the processor 110. If the processor 110 needs to use the instructions or the data again, the processor may directly invoke the instructions or the data from the memory. This avoids repeated access and reduces waiting time of the processor 110, thereby improving system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The charging management module 140 is configured to receive a charging input from a power supply device (such as a charger or a notebook computer). The charger may be a wireless charger or a wired charger. In some embodiments of wired charging, the charging management module 140 may receive a charging input from a wired charger through the USB interface 130. In some embodiments of wireless charging, the charging management module 140 may receive a wireless charging input by using a wireless charging coil of the electronic device.

When charging the battery 142, the charging management module 140 may further supply power to the electronic device through the power management module 141. The battery 142 may specifically include a plurality of batteries connected in series. The power management module 141 is configured to connect the battery 142, the charging management module 140, and the processor 110.

The power management module 141 is configured to connect the battery 142, the charging management module 140, and the processor 110. The power management module 141 receives an input from the battery 142 and/or the charging management module 140, and supplies power to the processor 110, the internal memory 121, the display 193, the camera 195, the wireless communication module 160, and the like. The power management module 141 may be further configured to monitor parameters such as a battery voltage, a current, a quantity of battery cycles, and a battery health status (leakage or impedance). In some other embodiments, the power management module 141 may alternatively be disposed in the processor 110.

The external memory interface 120 may be configured to be connected to an external non-volatile memory, to expand a storage capability of the electronic device. The external non-volatile memory communicates with the processor 110 by using the external memory interface 120, to implement a data storage function. For example, files such as music and a video are stored in the external non-volatile memory.

The internal memory 121 may include one or more random access memories (random access memory, RAM) and one or more non-volatile memories (non-volatile memory, NVM). The processor 110 may directly perform reading from or writing into the random access memory. The random access memory may be configured to store an executable program (for example, a machine instruction) of an operating system or another running program, and may be further configured to store data of a user and data of an application, and the like. The non-volatile memory may also store the executable program, the data of the user, the data of the application, and the like, which may be loaded into the random access memory in advance for direct reading and writing by the processor 110.

The touch sensor is also referred to as a “touch control device”. The touch sensor may be disposed on the display 193. The touch sensor and the display 193 constitute a touchscreen, which is also referred to as a “touch control screen”. The touch sensor is configured to monitor a touch operation performed on or near the touch sensor. The touch sensor may transfer the monitored touch operation to the application processor to determine a type of a touch event. A visual output related to the touch operation may be provided by using the display 193. In some other embodiments, the touch sensor may alternatively be disposed on a surface of the electronic device at a position different from that of the display 193.

The ambient light sensor is configured to sense ambient light brightness. For example, the ambient light sensor may measure light intensity of four channels of ambient light. The ambient light sensor outputs the measured light intensity of the four channels of the ambient light to the processor 110. The processor 110 may process the light intensity of the four channels of the ambient light output by the ambient light sensor to obtain light intensity of the ambient light. In a screen-on state, the electronic device may adaptively adjust brightness of the display based on the obtained light intensity of the ambient light.

The pressure sensor is configured to sense a pressure signal, and may convert the pressure signal into an electrical signal. In some embodiments, the pressure sensor may be disposed on the display 193. There are many types of pressure sensors, such as a resistive pressure sensor, an inductive pressure sensor, and a capacitive pressure sensor. When a touch operation is performed on the display 193, the electronic device monitors intensity of the touch operation by using the pressure sensor. The electronic device may also calculate a touch position based on a monitored signal of the pressure sensor. In some embodiments, touch operations that are performed at a same touch position but have different touch operation intensity may correspond to different operation instructions. For example, when a touch operation whose touch operation intensity is less than a first pressure threshold is performed on an SMS message application icon, an instruction for viewing an SMS message is executed. When a touch operation whose touch operation intensity is greater than or equal to the first pressure threshold is performed on the SMS message application icon, an instruction for creating an SMS message is executed.

In some embodiments, the electronic device may include 1 or N cameras 195, where N is a positive integer greater than 1. In this embodiment of this disclosure, types of the cameras 195 may be distinguished based on a hardware configuration and a physical position. For example, a camera disposed on a side on which the display 193 of the electronic device is located may be referred to as a front-facing camera, and a camera disposed on a side on which a rear cover of the electronic device is located may be referred to as a rear-facing camera. For another example, a camera with a short focal length and a large angle of view may be referred to as a wide-angle camera, and a camera with a long focal length and a small angle of view may be referred to as a common camera. The focal length and the angle of view are relative concepts with no specific parameter limitations. Therefore, the wide-angle camera and the common camera are also relative concepts, and may be specifically distinguished based on physical parameters such as the focal length and the angle of view.

The electronic device implements a display function by using the GPU, the display 193, the application processor, and the like. The GPU is a microprocessor for image editing and is connected to the display 193 and the application processor. The GPU is configured to perform mathematical and geometric computing for graphics rendering. The processor 110 may include one or more GPUs that execute program instructions to generate or change display information.

The electronic device may implement a photographing function by using the ISP, the camera 195, the video codec, the GPU, the display 193, the application processor, and the like. The GPU is configured to perform mathematical and geometric computing for graphics rendering. The processor 110 may include one or more GPUs that execute program instructions to generate or change display information. In this embodiment of this disclosure, a function of the GPU is used during frame drawing of each image frame, so that a finally displayed picture achieves a better display effect and better performance.

The ISP is configured to process data fed back by the camera 195. For example, during photographing, a shutter is pressed, light is transmitted to a photosensitive element of the camera through a lens, an optical signal is converted into an electrical signal, and the photosensitive element of the camera transmits the electrical signal to the ISP for processing, to convert the electrical signal into an image visible to a naked eye. The ISP may further perform algorithm optimization on noise and brightness of the image. The ISP may further optimize parameters such as exposure and a color temperature of a shooting scenario. In some embodiments, the ISP may be disposed in the camera 195. The camera 195 is configured to capture a still image or a video.

The digital signal processor is configured to process a digital signal, and may further process another digital signal in addition to the digital image signal. For example, when the electronic device selects a frequency, the digital signal processor is configured to perform Fourier transform or the like on frequency energy.

The display 193 is configured to display an image, a video, or the like. The display 193 includes a display panel. The display panel may be a liquid crystal display (LCD), an organic light-emitting diode (OLED), an active-matrix organic light-emitting diode or active-matrix organic light-emitting diode (AMOLED), a flexible light-emitting diode (FLED), a Miniled, a MicroLed, a Micro-oLed, a quantum dot light-emitting diode (QLED), or the like. In some embodiments, the electronic device may include 1 or N displays 193, where N is a positive integer greater than 1.

In this embodiment of this disclosure, the display 193 may be configured to display a page that the electronic device needs to display, and the display may further display a picture presentation interface, and display, in the picture presentation interface, an image shot by any one or more cameras 195.

A wireless communication function of the electronic device may be implemented by using the antenna 1, the antenna 2, the mobile communication module 150, the wireless communication module 160, a modem, the baseband processor, and the like.

The antenna 1 and the antenna 2 are configured to transmit and receive electromagnetic wave signals. Each antenna in the electronic device may be configured to cover one or more communication frequency bands. Different antennas may be further reused to improve antenna utilization.

The mobile communication module 150 may provide a wireless communication solution applied to the electronic device, including 2G/3G/4G/5G and the like. The mobile communication module 150 may receive an electromagnetic wave by using the antenna 1, perform processing such as filtering and amplification on the received electromagnetic wave, and transmit a processed electromagnetic wave to the modem processor for demodulation. The mobile communication module 150 may further amplify a signal obtained after modulation by the modem processor, and convert an amplified signal into an electromagnetic wave for radiation through the antenna 1. In some embodiments, at least some functional modules in the mobile communication module 150 may be disposed in the processor 110. In some embodiments, at least some functional modules in the mobile communication module 150 may be disposed in a same device as at least some modules in the processor 110.

The modem processor may include a modulator and a demodulator. The modulator is configured to modulate a to-be-sent low frequency baseband signal into a medium or high frequency signal. The demodulator is configured to demodulate a received electromagnetic wave signal into a low frequency baseband signal. Then, the demodulator transfers the low frequency baseband signal obtained through demodulation to the baseband processor for processing. The low frequency baseband signal is processed by the baseband processor and then transferred to the application processor. The application processor outputs a sound signal by using an audio device (not limited to the speaker 170A or the receiver 170B), or displays an image or a video by using the display 193. In some embodiments, the modem processor may be an independent device. In some other embodiments, the modem processor may be independent of the processor 110 and disposed in a same device as the mobile communication module 150 or another functional module.

The wireless communication module 160 may provide a wireless communication solution including a wireless local area network (WLAN) (for example, a wireless fidelity (Wi-Fi) network), BLUETOOTH (BT), a global navigation satellite system (GNSS), frequency modulation (FM), a near field communication (NFC) technology, an infrared (IR) technology, and the like applied to the electronic device. The wireless communication module 160 may be one or more devices integrating at least one communication processing module. The wireless communication module 160 receives an electromagnetic wave through the antenna 2, performs frequency modulation and filtering on an electromagnetic wave signal, and sends a processed signal to the processor 110. The wireless communication module 160 may further receive a to-be-sent signal from the processor 110, perform frequency modulation and amplification on the to-be-sent signal, and convert the to-be-sent signal into an electromagnetic wave for radiation through the antenna 2.

The SIM card interface 194 is configured to connect to a SIM card. The SIM card may be inserted into the SIM card interface 194 or removed from the SIM card interface 194 to implement contact with and separation from the electronic device. The electronic device may support one or more SIM card interfaces. The SIM card interface 194 may support a Nano SIM card, a Micro SIM card, a SIM card, and the like. A plurality of cards may be simultaneously inserted into a same SIM card interface 194. The SIM card interface 194 may also be compatible with an external memory card. The electronic device interacts with a network by using a SIM card, to implement functions such as a call and data communication. One SIM card corresponds to one subscriber number.

It may be understood that an interface connection relationship between the modules illustrated in this embodiment of the present disclosure is merely an example for description, and does not constitute a limitation on the structure of the electronic device. In some other embodiments of this disclosure, the electronic device may alternatively use an interface connection manner different from that in the foregoing embodiment, or use a combination of a plurality of interface connection manners.

Certainly, it may be understood that FIG. 7 shows merely an example description when the electronic device is in a form of a mobile phone. If the electronic device is in another device form such as a tablet computer, a handheld computer, a PC, a PDA, or a wearable device (for example, a smartwatch or a smart band), the structure of the electronic device may include fewer structures than those shown in FIG. 7 or may include more structures than those shown in FIG. 7. This is not limited herein.

It may be understood that a function of the electronic device usually needs to be implemented based on cooperation of software in addition to support of hardware. A software system of the electronic device may use a layered architecture, an event-driven architecture, a microkernel architecture, a microservice architecture, or a cloud architecture. In this embodiment of this disclosure, an Android® system with the layered architecture is used as an example to describe a software structure of the electronic device.

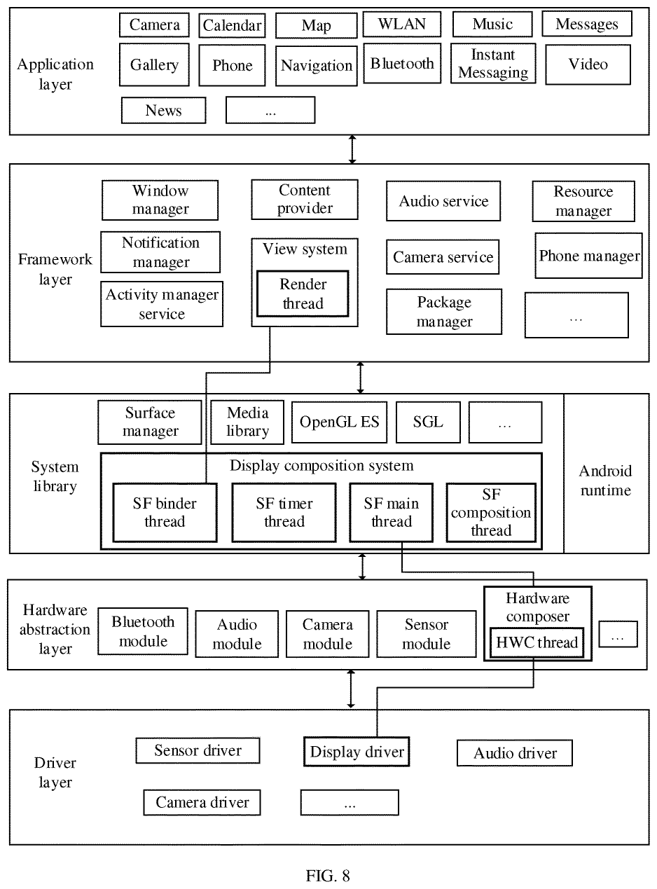

FIG. 8 is a schematic diagram of a layered architecture of a software system of an electronic device according to an embodiment of this disclosure. In the layered architecture, software is divided into several layers, and each layer has a clear role and task. The layers communicate with each other by using a software interface (for example, API).

In some examples, referring to FIG. 8, in this embodiment of this disclosure, the software of the electronic device is divided into five layers from top to bottom: an application layer, a framework layer (or referred to as an application framework layer), a system library and ANDROID runtime, an hardware abstraction layer (HAL), and a driver layer (or referred to as a kernel layer). The system library and ANDROID runtime may also be referred to as a native framework layer or a native layer.

The application layer may include a series of applications. As shown in FIG. 7, the application layer may include applications (APP) such as Camera, Gallery, Calendar, Map, WLAN, BLUETOOTH, News, Music, Video, Messages, Phone, Navigation, and Instant Messaging.

When an application works, the application may start a corresponding UI thread to start drawing and rendering of a display interface. When the UI thread needs to adjust a target layer in the display interface or create a target layer, the UI thread may request a corresponding SurfaceControl pointer from an SF main thread, so that the UI thread can draw layer content of the target layer, and set a layer attribute parameter and a display parameter of the target layer. Then, the UI thread may send the layer content, the layer attribute parameter, and the display parameter of the target layer to a render thread, so that the render thread draws and renders the target layer.

The framework layer provides an application programming interface (API) and a programming framework for the applications at the application layer. The application framework layer includes some predefined functions or services. For example, the application framework layer may include an activity manager, a window manager, a content provider, an audio service, a view system, a phone manager, a resource manager, a notification manager, a package manager, and the like. This is not limited in this embodiment of this disclosure.

The window manager is configured to manage a window program. The window manager may obtain a display size, determine whether there is a status bar, lock a screen, take a screenshot, and the like.

The content provider is configured to store and obtain data, and enable the data to be accessible to an application. The data may include a video, an image, audio, calls that are made and answered, browsing history and bookmarks, a phone book, and the like.

The view system includes visual controls such as a text display control and a picture display control. The view system may be configured to build an application. A display interface may include one or more views. For example, a display interface including an SMS message notification icon may include a view for displaying a text and a view for displaying a picture. In some embodiments, the view system may further include or start the render thread to complete operations such as drawing and rendering.

After the render thread receives the layer content, the layer attribute parameter, and the display parameter of the target layer from the UI thread, the render thread may draw the content of the target layer into a target buffer, and send the target buffer and the layer attribute parameter and the display parameter of the target layer to a display composition system (SurfaceFlinger (SF)) for storage.

The phone manager is configured to provide a communication function of the electronic device. For example, the phone manager may manage a call status (including initiating, answering, hanging up, or the like) of a call application.

The resource manager provides various resources for an application, for example, a localized string, an icon, a picture, a layout file, and a video file.

The notification manager enables an application to display a notification message in a status bar, and may be configured to convey a notification-type message. The message may automatically disappear after a short stay without user interaction. For example, the notification manager is configured to provide a notification of download completion, a message reminder, and the like. The notification manager may alternatively be a notification that appears in a top status bar of a system in a form of a graph or scroll bar text, for example, a notification of an application running in the background, or a notification that appears on a screen in a form of a dialog window. For example, text information is prompted in the status bar, an alert tone is made, the electronic device vibrates, or an indicator blinks.

The package manager is configured to manage application packages in an Android® system. The package manager enables an application to obtain detailed information about installed applications and services, permissions, and the like thereof. The package manager is further configured to manage events such as installation, uninstallation, and upgrade of an application.

The system library may include a plurality of functional modules, for example, a surface manager, a media library (Media Libraries), OpenGL ES, and SGL. The surface manager is configured to manage a display subsystem, and provide 2D and 3D layer fusion for a plurality of applications. The media library supports playback and recording in a plurality of common audio and video formats, a still image file, and the like. The media library may support a plurality of audio and video coding formats, for example, MPEG4, H.264, MP3, AAC, AMR, JPG, and PNG. The OpenGL ES is configured to implement three-dimensional graphics drawing, image rendering, composition, layer processing, and the like. The SGL is a drawing engine for 2D drawing.

The Android runtime includes a core library and an ART virtual machine. The android runtime is responsible for scheduling and management of the ANDROID system. The core library includes two parts: One part is a functional function that needs to be invoked by a java language, and the other part is a core library of ANDROID. The application layer and the application framework layer run on the ART virtual machine. The ART virtual machine executes java files at the application layer and the application framework layer as binary files. The ART virtual machine is configured to perform functions such as object lifecycle management, stack management, thread management, security and exception management, and garbage collection.

In this embodiment of this disclosure, the system library may further include a display composition system (SurfaceFlinger (SF)). The SF may include an SF binder thread, an SF timer thread, an SF main thread, and an SF composition thread (SF RenderEngine render thread). The SF binder thread is configured to communicate with another process or thread, the SF timer thread may indicate, after startup, the SF main thread to start layer composition, and the SF composition thread may perform layer composition by using a GPU.

In some embodiments, the SF binder thread may receive the target buffer and the layer attribute parameter and the display parameter of the target layer from the render thread, and store the target buffer and the layer attribute parameter and the display parameter of the target layer in the SF. A timer corresponding to the SF timer thread may start timing after receiving a Vsync signal, and trigger startup of the SF timer thread after the timing ends. After being started, the SF timer thread may indicate the SF main thread to start layer composition.

After receiving the indication, the SF main thread may cooperate with the SF composition thread to perform layer composition. For a specific implementation, refer to related descriptions in subsequent embodiments. Details are not described herein.

It should be noted that, compared with an existing layer composition procedure, in the layer composition procedure provided in this disclosure, when a hash value of a current frame is different from a hash value of a previous frame, the SF main thread uses a specific method to enable GPU composition and composition policy query to be performed in parallel, thereby improving layer composition efficiency and reducing layer composition duration. The specific used method is described in detail in subsequent embodiments, and details are not described herein.

The HAL is an interface layer between an operating system kernel and a hardware circuit, and is intended to abstract hardware. The HAL hides hardware interface details of a specific platform, provides a virtual hardware platform for an operating system, and makes the operating system hardware-independent and portable on a plurality of platforms. The HAL provides a standard interface to display a device hardware function to a higher-level Java API framework (for example, the framework layer). The HAL includes a plurality of library modules. Each module implements an interface for a specific type of hardware component, for example, an audio HAL audio module, a BLUETOOTH HAL BLUETOOTH module, a camera HAL camera module (which may also be referred to as a camera HAL or a camera hardware abstraction module), and a sensors HAL sensor module (or referred to as an Isensor service or a sensor service).

In this embodiment of this disclosure, the HAL further includes a hardware composer (HWC). For related descriptions of the hardware composer, refer to related content in the term explanation in the foregoing embodiments. Details are not described herein again.

In this embodiment of this disclosure, the HWC is configured to: after receiving a request for requesting to query a composition policy from the SF main thread, determine a composition manner of each layer (for example, the composition policy) based on layer information of all layers from the SF main thread, and return the composition policy to the SF main thread. The HWC is further configured to: after receiving, from the SF main thread, information (for example, an identifier of a buffer) about an intermediate layer, and an indication indicating composition and send-for-display, composite the intermediate layer and all layers whose composition manners are HWC composition, to obtain a final current frame image and send the image for display.

The kernel layer is a layer between hardware and software. The kernel layer includes at least a display driver, a camera driver, an audio driver, a sensor driver, a battery driver, and the like. This is not limited in this disclosure. The sensor driver may specifically include a driver of each sensor included in the electronic device, for example, a driver of an ambient light sensor. When receiving a send-for-display indication from the HWC, the display driver may control a display to display the current frame image from the HWC.

The technical solutions provided in embodiments of this disclosure may all be implemented in an electronic device having the foregoing hardware architecture or software architecture.

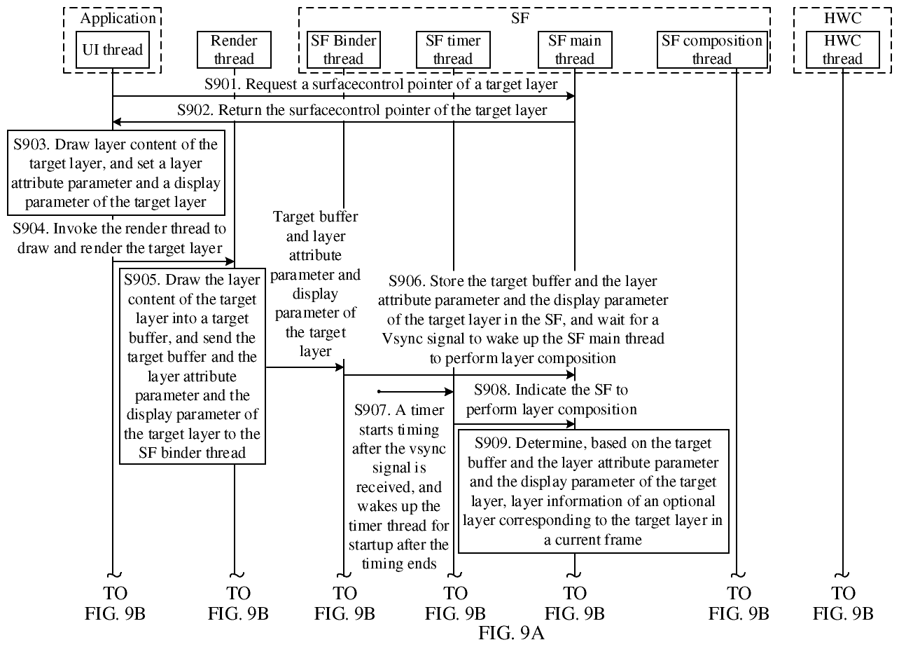

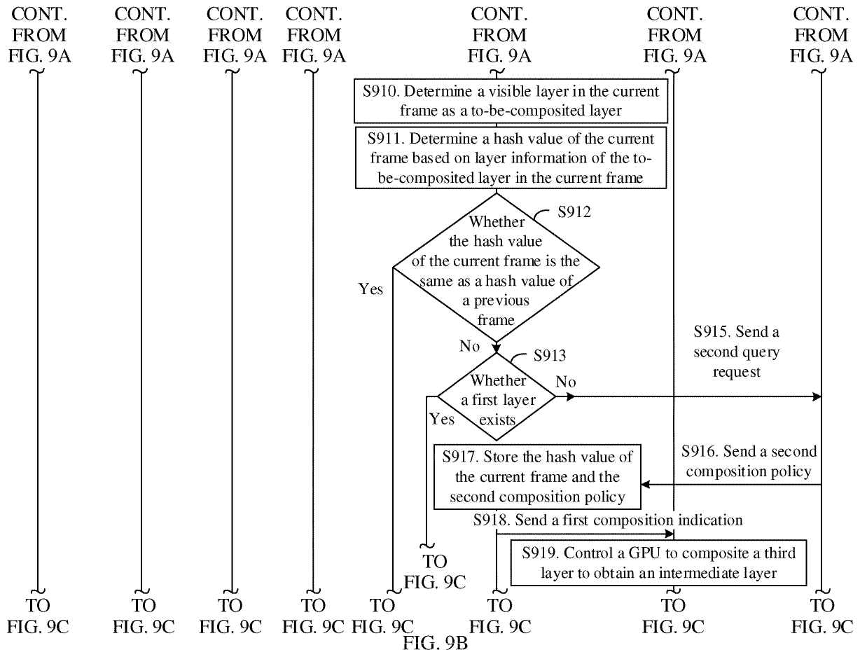

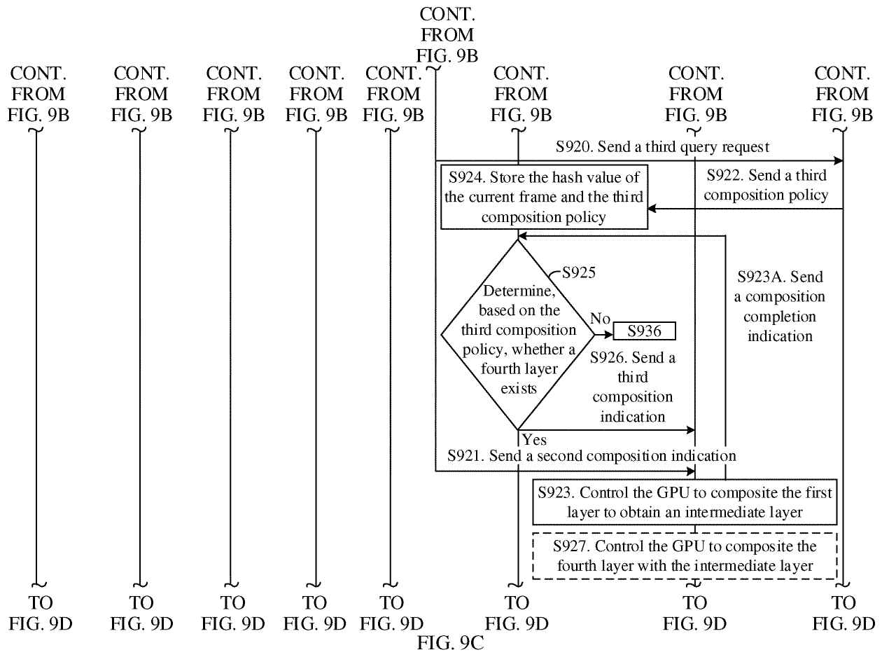

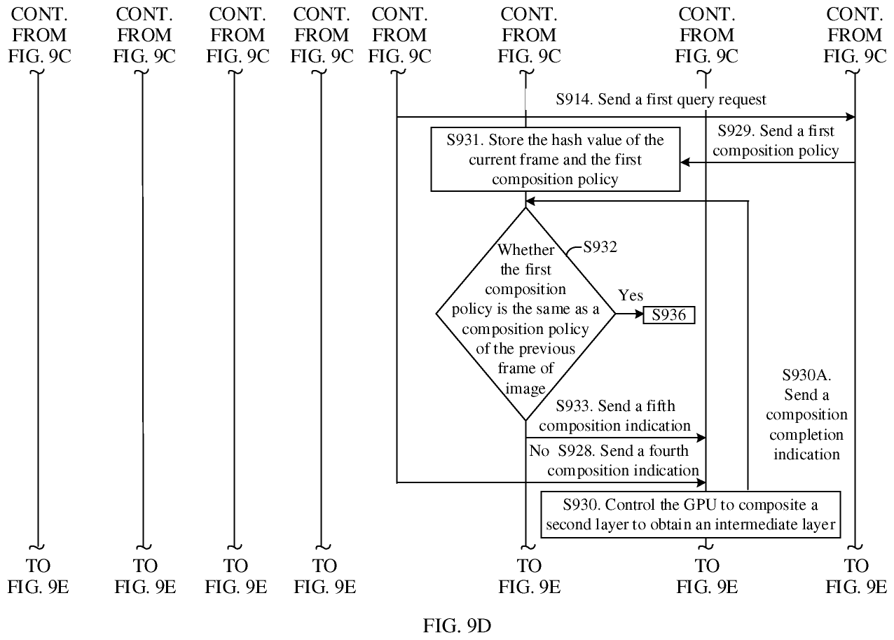

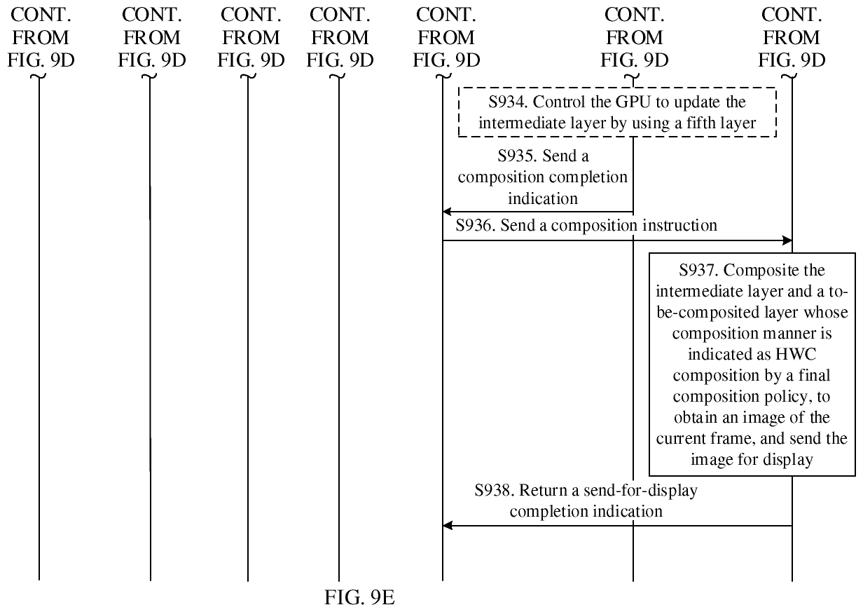

Based on the software architecture shown in FIG. 8, the following describes a layer composition manner provided in an embodiment of this disclosure with reference to FIG. 9A to FIG. 9E. FIG. 9A to FIG. 9E are a schematic flowchart of a layer composition method according to an embodiment of this disclosure. Referring to FIG. 9A to FIG. 9E, the layer composition method may include S901-S938.

S901. After responding to a layer drawing instruction, a UI thread sends a first request to an SF main thread.

The first request is used to request a SurfaceControl pointer of a target layer, and an identifier such as a name of the target layer may be written into the first request. The target layer may be one layer, or may be a plurality of layers.

In this embodiment of this disclosure, the layer drawing instruction may be generated after a user performs any possible operation on an electronic device. For example, the operation may be an operation of opening an application, exiting an application, switching an application page, or sliding an application page.

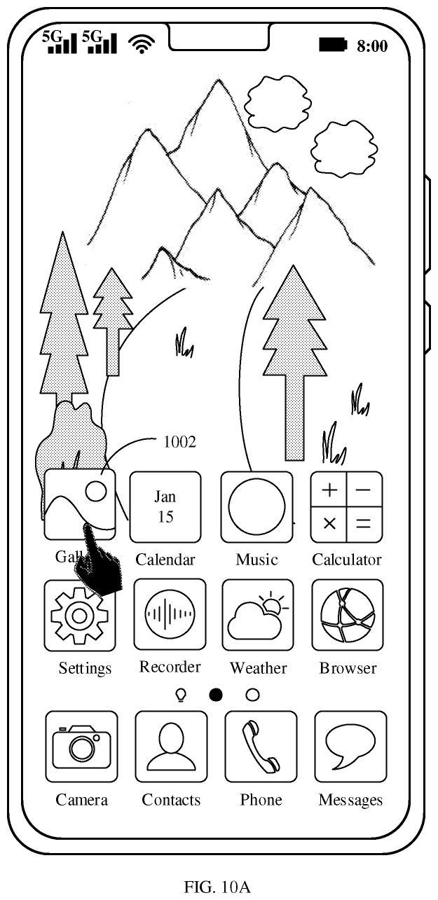

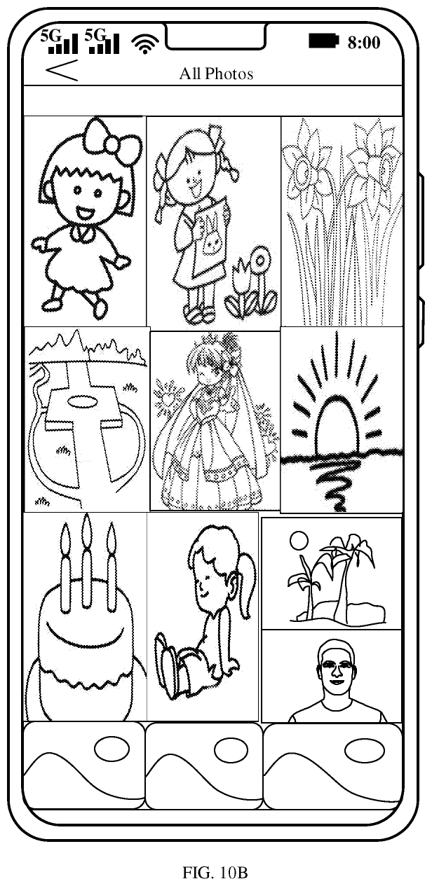

For example, the electronic device is a mobile phone, and the layer drawing instruction is triggered by an operation performed by the user for opening an application. Referring to FIG. 10A, a desktop of the mobile phone may display icons of a plurality of applications. When the user wants to view a picture in Gallery, the user may perform a tap operation on an icon 1002 of Gallery on the desktop. In response to the tap operation, the mobile phone may first display an application startup animation, for example, gradually enlarging a blurry picture by using the icon of Gallery as a center until the picture is enlarged to full screen. After the startup animation is played, a picture presentation interface shown in FIG. 10B may be displayed. In a process from triggering to open Gallery and displaying the picture presentation interface, the mobile phone displays a plurality of frames of pictures, including a plurality of frames of pictures that may be included in the application startup animation and a frame of picture of the picture presentation interface. Each frame of picture may include a plurality of layers, and each layer may be used as a target layer. The layer drawing instruction may be automatically generated by the mobile phone or an application of the mobile phone after the user performs the tap operation for opening Gallery and a frame of picture is displayed each time.

In this disclosure, Gallery may be referred to as a first application, and the tap operation performed by the user on the icon 1002 of Gallery may be referred to as a first operation. The layer composition method provided in this disclosure may be performed in a startup process of the first application after the user performs the first operation. The startup process of the first application may be from performing the first operation by the user to displaying a main interface by the first application.

Certainly, the layer composition method provided in this disclosure may also be performed in a display process of another dynamic picture.

Certainly, in practice, specific time and a specific module for generating the layer drawing instruction may be determined according to an actual requirement. This is not specifically limited in this disclosure.

In some embodiments, the first request may be specifically a layer creation request for requesting to create a new layer, and the new layer may be the target layer. The first request may alternatively be a layer adjustment request for requesting to adjust a created layer, and the created layer is the target layer. Certainly, the SF main thread may further determine, based on an identifier of the target layer carried in the first request, whether the target layer has been created, to determine whether the first request is specifically a layer creation request or a layer adjustment request. This is not specifically limited in this disclosure.

In an Android® system, the SurfaceControl pointer is used to control and manage display of a graphical interface (for example, a layer). The pointer is a part of an Android graphics system and is used to process a window, a surface, and an operation related to screen display. The window and the surface may be considered as layers. Specifically, the SurfaceControl pointer may be specifically an address pointer that points to a storage area in a memory allocated by the SF main thread to the target layer. For example, the memory may be specifically a random access memory (RAM). The storage area allocated to the target layer in the memory may be referred to as an off-screen buffer.

S902. The SF main thread sends the SurfaceControl pointer of the target layer to the UI thread.

If the target layer is a newly created layer, after receiving the first request, the SF main thread may allocate the storage area to the target layer, and return the corresponding SurfaceControl pointer to the UI thread.

If the target layer is not a newly created layer, after receiving the first request, the SF main thread may determine, based on the identifier of the target layer carried in the first request, the storage area corresponding to the target layer, and then return the corresponding SurfaceControl pointer to the UI thread.

S903. Based on the SurfaceControl pointer of the target layer from the SF main thread, the UI thread draws layer content of the target layer, and sets a layer attribute parameter and a display parameter of the target layer.

After obtaining the SurfaceControl pointer of the target layer, the UI thread may draw the layer content of the target layer in the memory area corresponding to the pointer, and set the corresponding layer attribute parameter and display parameter.

For example, the layer attribute parameter may include a blur parameter, transparency, a position, a size, a name, a type, and visibility. The display parameter may include a color, transparency, a blending mode, a depth sorting (or referred to as Z-axis sorting), a clipping parameter, an occlusion parameter, and the like.

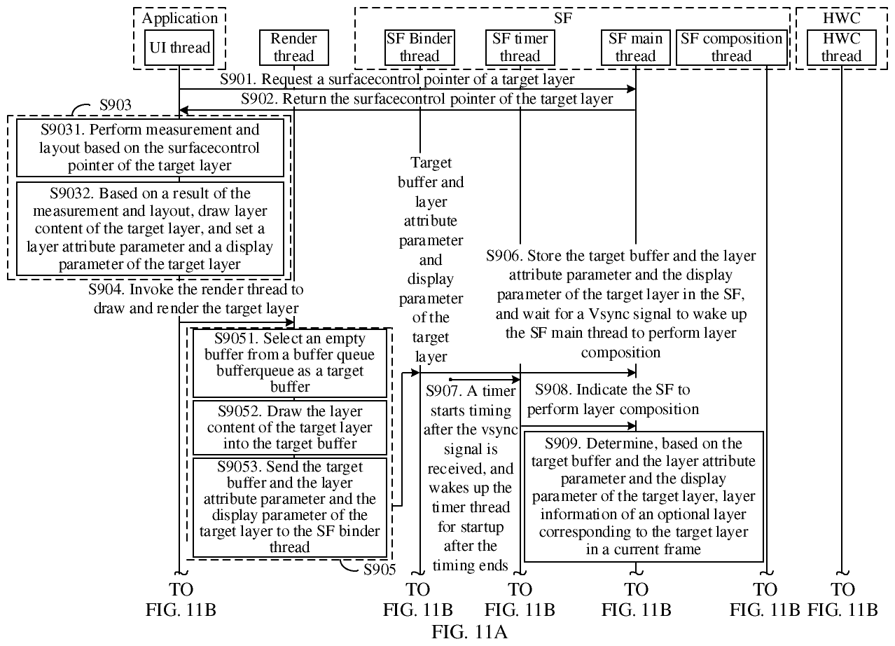

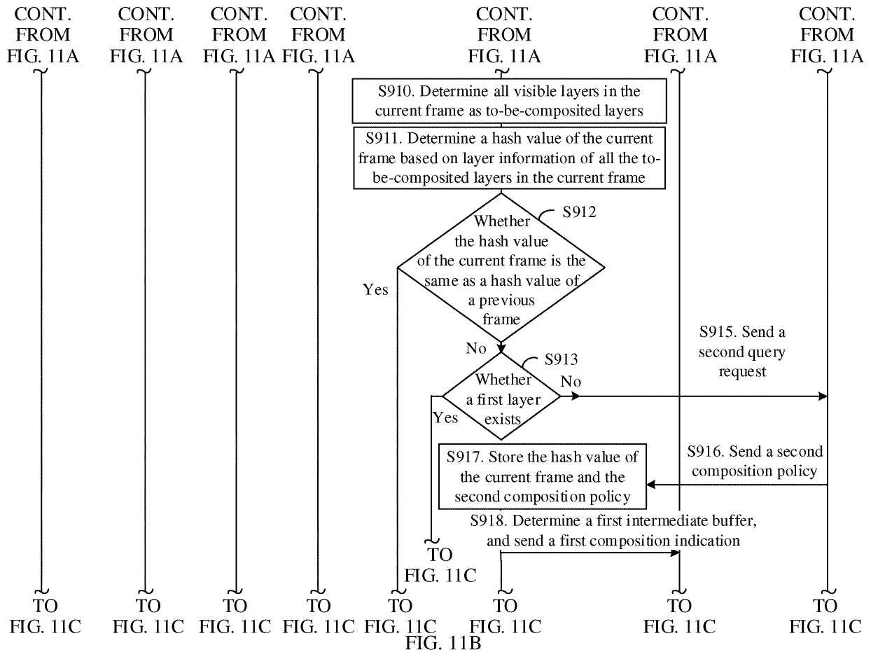

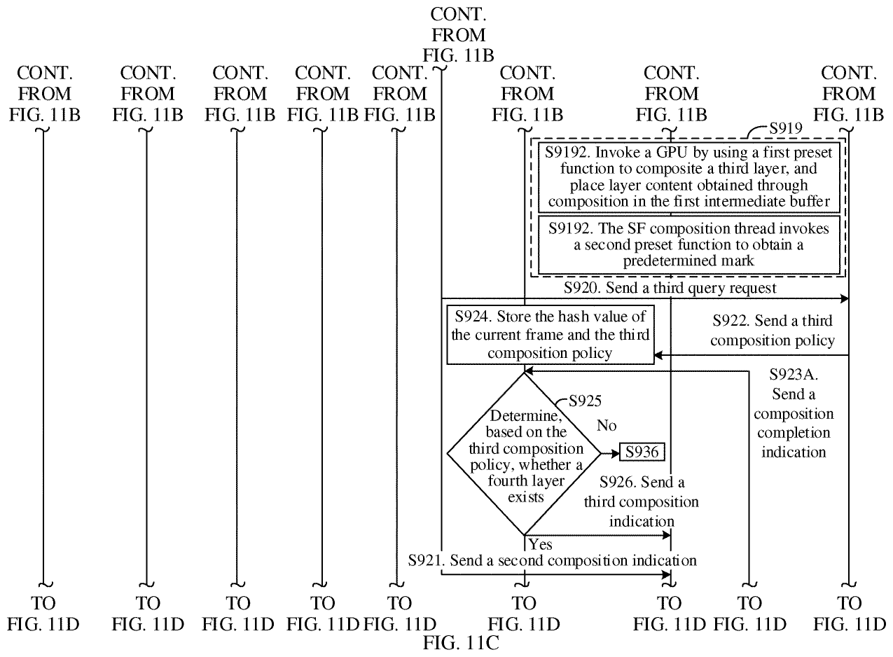

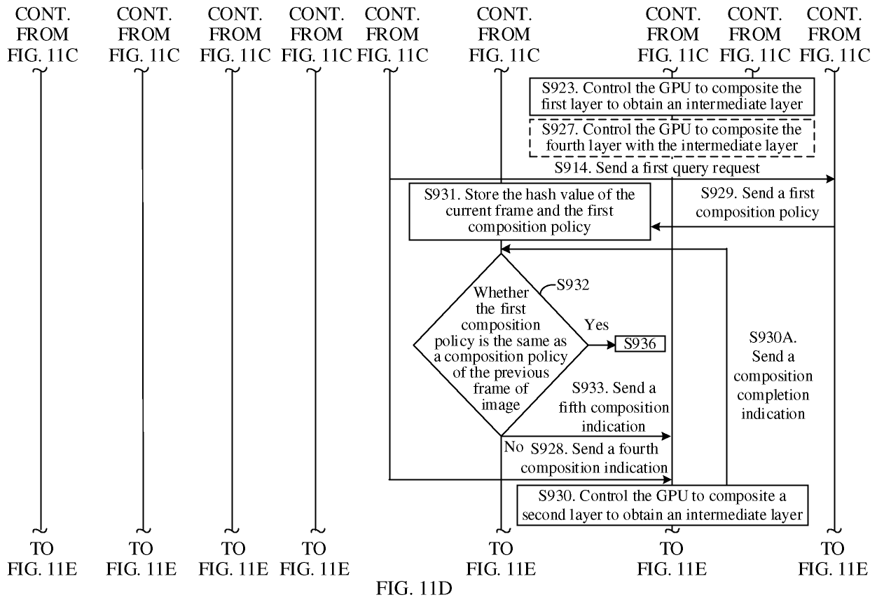

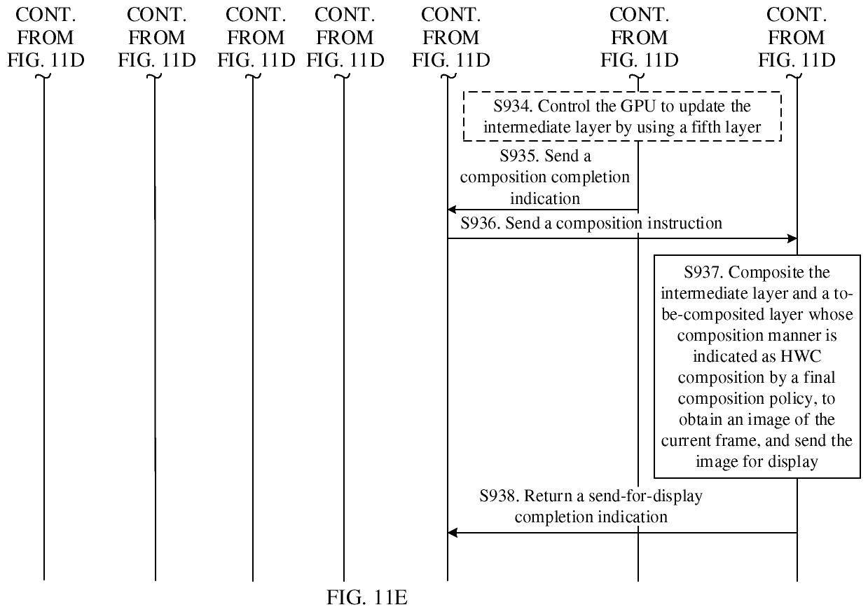

In some embodiments, with reference to FIG. 9A to FIG. 9E, referring to FIG. 11A to FIG. 11E, S903 may specifically include S9031 and S9032.

S9031. The UI thread performs measurement and layout based on the SurfaceControl pointer of the target layer from the SF main thread.

Based on the measurement and layout (layout measure), the UI thread may determine a size and a position of each element in the layer content of the target layer, to facilitate subsequent drawing of the layer content of the target layer.

S9032. Based on a result of the measurement and layout, the UI thread draws the layer content of the target layer, and sets the layer attribute parameter and the display parameter of the target layer.

In an embodiment, the UI thread may invoke an OpenGL ES3.1 interface or a Vulkan library function interface to draw the layer content of the target layer. Certainly, in practice, the UI thread may draw the target layer in any feasible manner. A drawing manner of the UI thread is not specifically limited in this embodiment of this disclosure.

After completing drawing of the target layer, the UI thread may invoke a render thread to further draw and render the target layer, for example, perform S904.

S904. The UI thread invokes the render thread to draw and render the target layer.

In a possible implementation, the UI thread may specifically invoke the render thread by using a cross-process invocation mechanism binder, to wake up the render thread, and indicate the render thread to draw and render the target layer. Specifically, the UI thread may send a drawing instruction to the render thread by using the cross-process invocation mechanism, to indicate the render thread to draw and render the target layer. The drawing instruction may carry a pointer or an identifier of the memory area in which the UI thread draws the target layer.

S905. The render thread in the mobile phone draws the layer content of the target layer into a target buffer, and sends the target buffer and the layer attribute parameter and the display parameter of the target layer to an SF binder thread.

After the render thread receives invocation from the UI thread or receives the drawing instruction from the UI thread, the render thread may draw the layer content of the target layer into the target buffer, and send the target buffer and the layer attribute parameter and the display parameter of the target layer to the SF binder thread, so that the SF performs subsequent layer composition.

In some embodiments, with reference to FIG. 9A to FIG. 9E, referring to FIG. 11A to FIG. 11E, S905 may specifically include S9051-S9053.

S9051. The render thread selects an empty buffer from a buffer queue (bufferqueue) as the target buffer.

In a possible implementation, the render thread may select the empty buffer from the bufferqueue as the target buffer according to a first-in first-out principle. Specifically, the render thread may select an empty buffer that enters the bufferqueue earliest as the target buffer.

In another possible implementation, the render thread may select the empty buffer from the bufferqueue as the target buffer based on a priority. Specifically, the render thread may select, based on a specific condition (for example, a buffer size, availability, or a special requirement), an empty buffer that better meets the specific condition, for example, has a highest priority, as the target buffer.

Certainly, an actual manner in which the render thread selects the empty buffer from the bufferqueue as the target buffer may be determined according to an actual requirement. This is not specifically limited in this disclosure.

S9052. The render thread draws the layer content of the target layer into the target buffer.

Specifically, the render thread may draw each element in the layer content of the target layer into the target buffer by using an open graphics library (OpenGL) instruction. In this process, the render thread may further use some rendering techniques (for example, batch processing, clipping, and the like) to optimize drawing performance.

After completing drawing of the target layer, the render thread needs to indicate, to the SF, that layer composition can be started. In this case, the render thread needs to notify the SF main thread of data related to the target layer by using the SF binder thread, for example, perform S9053.

S9053. The render thread sends the target buffer and the layer attribute parameter and the display parameter of the target layer to the SF binder thread.

Specifically, because an amount of data stored in the target buffer is relatively large, it is not convenient to directly transmit all the data. Herein, the render thread may specifically send an address or a pointer of the target buffer and the layer attribute parameter and the display parameter of the target layer to the SF binder thread. In addition, the layer attribute parameter and the display parameter of the target layer may be alternatively stored in the target buffer. In this case, the render thread may send only the address or the pointer of the target buffer to the SF binder thread.

In some embodiments, when sending the target buffer and the layer attribute parameter and the display parameter of the target layer, the render thread may further send first indication information to the SF binder thread. The first indication information is used to indicate the SF to perform layer composition.

After receiving information about the target layer (the target buffer and the layer attribute parameter and the display parameter of the target layer) from the render thread, the SF binder thread may store the information in the SF for use by the SF main thread during layer composition. In addition, the SF binder thread may request a Vsync signal (which may be specifically a Vsync-SF signal) to wake up the SF main thread to perform layer composition. Certainly, in practice, the Vsync signal is not obtained through requesting, but is periodically generated by hardware in the electronic device based on a screen refresh rate. Therefore, after receiving the information about the target layer from the render thread, the SF binder thread waits for the Vsync signal to wake up the SF main thread to perform layer composition, for example, performs S906.

S906. The SF binder thread stores the target buffer and the layer attribute parameter and the display parameter of the target layer in the SF, and waits for the Vsync signal to wake up the SF main thread to perform layer composition.

For example, the target buffer stored by the SF binder thread in the SF may be specifically the address or the pointer of the target buffer. If both the layer attribute parameter and the display parameter of the target layer exist in the target buffer, S906 may be specifically that the SF binder thread stores the address or the pointer of the target buffer in the SF.

S907. A timer in the SF starts timing after the Vsync signal is received, and wakes up an SF timer thread for startup after the timing ends.

After startup, the timer thread indicates the SF main thread to start layer composition. Generally, timing duration of the timer is short, to ensure that a layer composition interval between two frames of images matches a system time interval corresponding to a refresh rate. For example, when the refresh rate is 120 Hz, the system time interval may be 1000/120=8.3 ms or a multiple thereof.

In a possible implementation, the timer in the SF may register a callback function for a Vsync signal at a hardware abstraction layer, so that when a new Vsync signal appears, the hardware abstraction layer notifies the timer by using the callback function, to cause the timer to start timing.

Herein, there may be the following two objectives of using the Vsync signal to wake up, sequentially through the timer and the timer thread, the SF main thread to start layer composition.

(1) In an entire layer composition and send-for-display process, the SF main thread is usually responsible for processing a large quantity of tasks, and these tasks usually need to be performed at a high frequency. The SF main thread may face high working pressure, especially during processing of complex interfaces and a large amount of dynamic content. The timer thread may decouple the SF main thread from a direct response to the Vsync signal, thereby reducing working pressure of the SF main thread. In addition, in this case, if an execution occasion or frequency of the SF main thread needs to be changed, only a parameter of the timer needs to be adjusted, rather than modifying code of the SF main thread. This decoupling manner improves program flexibility and maintainability.

(2) Due to problems such as a hardware limitation (the SF cannot accurately respond to the Vsync signal), an inter-thread race condition in a multi-thread environment, and high system load, a delay or a jitter may occur when the SF main thread directly responds to the Vsync signal. The timer thread may trigger execution of the SF main thread based on a predetermined time interval, avoiding the foregoing problems that may be encountered when the Vsync signal is directly responded to, so that the Vsync signal wakes up the SF main thread for layer composition with higher stability and accuracy.

S908. The SF timer thread sends second indication information to the SF main thread.

The second indication information is used to indicate the SF main thread to perform layer composition.

S909. The SF main thread determines, in response to the second indication information based on the target buffer and the layer attribute parameter and the display parameter of the target layer, layer information of an optional layer corresponding to the target layer in all layers of a current frame.

The layer information may include an identifier or a pointer of a buffer corresponding to the layer, a layer attribute parameter, and a display parameter. The identifier or the pointer of the buffer corresponding to the layer may be specifically a handle of the buffer corresponding to the layer.

After receiving an indication (for example, the second indication information) of the timer thread, the SF main thread first obtains all layers that have been registered with the SF currently and corresponding layer information, and uses these layers as layers of the current frame. Then, because layer information of these layers is obtained in a display process of a previous frame in this case, the SF main thread needs to update, based on the information about the target layer, the layer information of the optional layer corresponding to the target layer in all the layers of the current frame. The SF main thread may determine, by using layer names, the optional layer corresponding to the target layer in all the layers of the current frame. For example, names of all the layers of the current frame may include: a, A, Ab, and ab, and a name of the target layer may be A. In this case, a layer named A in all the layers of the current frame may be determined as the optional layer corresponding to the target layer.

It should be noted that a plurality of layers exist in a frame of image, layer information of each layer may change in a next frame of image, and each layer may correspond to a different application. Therefore, S901-S909 may be performed a plurality of times in one Vsync period or a plurality of similar procedures are performed in parallel. Each time the SF main thread obtains latest layer information of a layer, the SF main thread updates layer information of the corresponding layer before layer composition, to ensure that a finally displayed image meets an expectation.

To improve composition efficiency, for an invisible layer that does not need to be displayed on a display, the SF main thread may not perform any processing on the invisible layer, but only a visible layer that needs to be displayed on the display is composited. Based on this, after completing updating the layer information of the layer in the current frame, the SF main thread needs to select a visible layer as a to-be-composited layer of the current frame, for example, perform S910.

S910. The SF main thread uses a visible layer in all the layers of the current frame as a to-be-composited layer of the current frame.

The visible layer is a layer that ultimately needs to be presented on the display, and visibility in a layer attribute parameter of the visible layer is “visible”. Certainly, in practice, “visible” may be a specific value. For example, a value of the visibility in the layer attribute parameter may be “true” or “false”. When the value of the visibility is “true”, the visibility is “visible”, for example, the corresponding layer is a visible layer. When the value of the visibility is “false”, the visibility is “invisible”, for example, the corresponding layer is an invisible layer.

After obtaining layer information of the to-be-composited layer of the current frame, the electronic device may further determine whether two procedures of composition policy query and GPU composition can be performed in parallel. Whether a first detection result meets a parallel condition may be specifically determined. In this disclosure, the parallel condition may be referred to as a first condition.

In some embodiments, the first detection result may be a result about whether a hash value of the current frame is the same as a hash value of the previous frame. For example, S911 and S912 are performed after S910. It should be noted that the electronic device may specifically obtain layer information of all to-be-composited layers or layer information of some to-be-composited layers herein.

S911. The SF main thread determines the hash value of the current frame based on the layer information of the to-be-composited layer in the current frame.

In practice, the SF may determine the hash value of the current frame based on the layer information of all the to-be-composited layers in the current frame.

Specifically, the SF main thread may process the layer information of the to-be-composited layer by using a specific hash algorithm, to obtain the hash value of the current frame. For example, code of the hash algorithm may be as follows:
wint64_t outputlayerhash=0; for (auto*layer: getOutputLayersOrderedByZ( ) ){if (layer==peekThrouphlayer) {// No longer needed, although it should not show up again, so // resetting it is not truly needed either.peekThroughlayer=nuliptr; // peekThroughLayer was already drawn ahead of its z order.continue;} bool skiplayer=false; const auto& overrideInfo=layer->getState.overrideInfo; if (overrideInfo.buffer!=nullptr){if(previousOverride&&overrideInfo.buffer->getBuffer==previousOverride){ALOGV(“skipping Redundant Buffer”); Skiplayer=true; }else {// First layer with the override bufferif.if(overrideInfo.peekThroughLayer) {peekThroughLayer=overrideInfo.peekThroughLayer; //Draw peekThroughLayer first. Overridez=true; includeGeometry=true; constexpr bool isPeekingthrouph=true; peekThroughLayer->writeStateToHwC(includeGeometry, false, Z++, overrideZ, isPeekingThrough); outputLayerHash\hat{ }=android::hashCombine(reinterpret_cast<uint64_t>(&peekThroughlayer->getlayerFE), z, includeGcometry,overridez,isPeekingThrough, peekThroughlayer->requiresClientComposition); } previousOverride=overrideInfo.buffer->getBuffer;}}

S912. The SF main thread determines whether the hash value of the current frame is the same as the hash value of the previous frame.

If the hash value of the current frame is different from the hash value of the previous frame, it may be considered that there is a change between a layer (for example, the to-be-composited layer) that needs to be displayed in the current frame and a layer that needs to be displayed in the previous frame. In this case, according to existing logic, it is determined that the first detection result does not meet the parallel condition, and composition policy query and GPU composition need to be performed in series. However, this causes long time consumed for layer composition, and may further cause a frame loss problem. Therefore, to avoid serial execution of composition policy query and GPU composition, in this case, the SF main thread may first determine whether a first layer that meets a preset condition exists in all the to-be-composited layers of the current frame, for example, perform S913. If the first layer exists, the first layer may be controlled to perform GPU composition, and composition policy query is performed at the same time. For example, composition policy query and GPU composition are performed in parallel, thereby improving layer composition efficiency.

If the hash value of the current frame is the same as the hash value of the previous frame, it may be considered that there is no change between a layer that needs to be displayed in the current frame and a layer that needs to be displayed in the previous frame. In this case, it is determined that the first detection result meets the parallel condition, and then composition policy query (controlling an HWC to query a composition policy) and GPU composition (controlling a GPU to composite a second layer whose composition manner is GPU composition in a composition policy in the previous frame) may be performed in parallel, for example, S914 and S928 are started at the same time.

S913. The SF main thread determines whether the first layer that meets the preset condition exists in all the to-be-composited layers of the current frame.

The preset condition may be obtained by a designer of the electronic device based on a function limitation of the HWC, statistical data of layers that need to be composited by the GPU in practice, and work experience. In this disclosure, the first layer may be referred to as a first target layer.

For example, the preset condition may include any one or more of the following: A layer attribute parameter or a display parameter of a layer changes; a layer is a newly added layer, a layer attribute parameter includes a first mark, and the first mark is used to indicate to use the GPU for composition; a layer is a newly added layer, and a buffer size of the layer is greater than a preset size (for example, 2160px*2160px); a composition manner of a layer in the previous frame is GPU composition, and a position of the layer changes or a visible area of the layer becomes larger; or a position of a layer is rotated 180° compared with that in the previous frame. The buffer size of the layer may be obtained from a memory based on a buffer pointer of the layer. The newly added layer is a layer that does not appear in the previous frame, for example, a layer that does not exist in the previous frame.

The first mark in the layer attribute parameter may be as follows: In a case that the SF main thread obtains all the to-be-composited layers, after a to-be-composited layer that needs to be composited by the GPU is determined according to any feasible rule or manner, the first mark is added to a layer attribute parameter of such a to-be-composited layer.

Certainly, in practice, the preset condition may be any other feasible condition, and may be specifically determined according to an actual requirement. This is not specifically limited in this disclosure.

When determining that the first layer that meets the preset condition does not exist in all the to-be-composited layers of the current frame, the SF main thread needs to perform composition policy query and GPU composition in series, for example, sequentially perform S915-S919.

When determining that the first layer that meets the preset condition exists in all the to-be-composited layers of the current frame, the electronic device may perform GPU composition (compositing the first layer) and control the HWC to query the composition policy in parallel. Specifically, when delivering the first layer to the GPU for composition, the SF main thread may query the composition policy based on the layer information of all the to-be-composited layers by using the HWC. For example, S920 and S921 are started at the same time.

S914. The SF main thread sends a first query request to an HWC thread.

The first query request carries the layer information of all the to-be-composited layers, and indicates that a composition manner of the second layer is GPU composition. The second layer is a layer that is in all the to-be-composited layers and whose composition manner is GPU composition in the composition policy in the previous frame. For example, if the composition policy in the previous frame indicates that a composition manner of a layer A (A may be a name of the layer) is GPU composition, the layer A is the second layer.

Specifically, an implementation of indicating that the composition manner of the second layer is GPU composition may be adding the first mark to layer information of the second layer. The first query request is used to request to query the composition policy, and requesting to query the composition policy includes requesting to query a composition manner of a to-be-composited layer. This applies to another similar query request subsequently, and details are not described again below.

In some embodiments, the first mark may be added by the SF main thread to the layer information of the second layer before S914 and after S912 in a case in which it is determined that the hash value of the current frame is the same as the hash value of the previous frame.

After receiving the first query request from the SF main thread, the HWC thread may obtain a first composition policy based on the request and return the first composition policy to the SF main thread. For example, S929 is performed after S914.

S915. The SF main thread sends a second query request to the HWC thread.

The second query request carries the layer information of all the to-be-composited layers, and the second query request is used to request to query a composition policy.

In some embodiments, if layer information of a to-be-composited layer exists in a buffer of the to-be-composited layer, the second query request may carry identifiers of buffers of all the to-be-composited layers instead of the layer information of all the to-be-composited layers. This applies to similar content in subsequent embodiments.

S916. In response to the second query request, the HWC thread determines a second composition policy based on the layer information of all the to-be-composited layers, and sends the second composition policy to the SF main thread.

After receiving the second query request from the SF main thread, the HWC thread may determine a composition manner of each to-be-composited layer based on a capability of the HWC thread and the layer information of all the to-be-composited layers, for example, obtain the second composition policy. After the second composition policy is obtained, the second composition policy may be sent to the SF main thread.

S917. The SF main thread receives the second composition policy from the HWC thread, and stores the hash value of the current frame and the second composition policy.

After storing the hash value of the current frame and the second composition policy, the SF may use the hash value of the current frame and the second composition policy as a hash value of a previous frame and a composition policy of the previous frame in a layer composition procedure in a next frame.

In a possible implementation, specific storage space may exist in the SF, and the specific storage space is used to store a previous-frame variable. The previous-frame variable is used to store the hash value of the previous frame and the composition policy of the previous frame. Each time the SF main thread stores the hash value of the current frame and the composition policy from the HWC thread (for example, the second composition policy/a third composition policy/the first composition policy/a fifth composition policy), content in the previous-frame variable may be updated by using the hash value of the current frame and the composition policy from the HWC thread. In this way, in a layer composition procedure in a next frame, corresponding data may be obtained from the previous-frame variable for use.

S918. The SF main thread sends a first composition indication to an SF composition thread.

The first composition indication carries layer information of a third layer whose composition manner is GPU composition in the second composition policy and an identifier of a first intermediate buffer. The first composition indication is used to indicate to place, in the first intermediate buffer, an intermediate layer composited from the third layer. The first intermediate buffer may be an empty buffer selected by the SF main thread from the bufferqueue. For a specific implementation in which the SF main thread selects the empty buffer from the bufferqueue, refer to related descriptions after S9051 in the foregoing embodiment. Details are not described herein again.

In some embodiments, layer information of a layer may all exist in a buffer of the layer. In this case, the layer information of the layer sent between different threads may be specifically an identifier or a pointer of the buffer of the layer. This applies to subsequent embodiments.

It should be noted that there is no inevitable sequence between S917 and S918. S917 may be first performed, or S918 may be first performed, or S917 and S918 may be performed at the same time.

S919. In response to the first composition indication, the SF composition thread controls the GPU to composite the third layer to obtain the intermediate layer.

Specifically, the SF composition thread controls the GPU to composite the third layer, and may specifically control the GPU to fuse layer content of all third layers into the first intermediate buffer based on layer information of the third layers. In this case, a layer in the first intermediate buffer is an intermediate layer (which specifically means that layer content in the first intermediate buffer is layer content of the intermediate layer).

After obtaining the intermediate layer, the SF composition thread may notify the SF main thread of this case, so that the SF main thread can perform a subsequent composition procedure. Specifically, the SF composition thread may send, to the SF main thread, a composition completion indication indicating that composition of the intermediate layer is completed, for example, perform S935.

In some embodiments, with reference to FIG. 9A to FIG. 9E, referring to FIG. 11A to FIG. 11E, S918 may include S918A, and S919 may include S9191 and S9192.

S918A. The SF main thread selects an empty buffer from the bufferqueue as the first intermediate buffer, and sends the first composition indication to the SF composition thread.

S9191. In response to the first composition indication, the SF composition thread invokes the GPU by using a first preset function to composite the third layer, and places layer content obtained through composition in the first intermediate buffer.

The first preset function is used to indicate the GPU to work asynchronously, for example, indicate the GPU to execute, in parallel when executing another task, a task of compositing the third layer and placing layer content of a layer obtained through composition in the first intermediate buffer.

For example, the first preset function may be a glFlush function.

S9192. The SF composition thread invokes a second preset function to obtain a predetermined mark.

The predetermined mark is used to indicate that GPU composition is completed or not completed. For example, the second preset function may be a gl function, and the predetermined mark may be Fence.

In the SF, invoking the gl function to obtain Fence used to track whether GPU composition ends is a mechanism for ensuring that a layer composition operation has been completed. Fence is a synchronization object used to transfer a signal between a plurality of threads or processes. In the SF, Fence is used to indicate whether a layer composition operation on the GPU is completed. After indicating the GPU to perform layer composition, the SF composition thread creates a Fence object and transfers the Fence object to the GPU. After layer composition is completed, the GPU marks Fence as completed. For example, in this case, Fence is used to indicate that GPU composition is completed.

Therefore, to learn in time whether the GPU completes composition, the SF composition thread may obtain Fence in real time or periodically by using the gl function, and return Fence to the SF main thread. If Fence indicates that GPU composition is completed, it is equivalent to that the SF composition thread returns a composition completion indication to the SF main thread.

In subsequent embodiments, specific implementations like S918 and S919 are similar, and details are not described below.

S920. The SF main thread sends a third query request to the HWC thread.

The third query request carries the layer information of all the to-be-composited layers, and indicates that a composition manner of the first layer is GPU composition. Specifically, an implementation of indicating that the composition manner of the first layer is GPU composition may be adding the first mark to the layer information of the first layer. The third query request is used to request to query a composition policy.

In some embodiments, the first mark may be added by the SF main thread to the layer information of the first layer before S920 and after S913 in a case in which it is determined that the first layer exists.

S922 is performed after S920.

S921. The SF main thread sends a second composition indication to the SF composition thread.

The second composition indication carries layer information of all first layers, and the second composition indication is used to indicate to composite the second layer into the first intermediate buffer.

After receiving the layer information of all the first layers from the SF main thread, the SF composition thread may control the GPU to composite all the first layers to obtain an intermediate layer, for example, perform S923.

S922. In response to the third query request, the HWC thread determines a third composition policy, and sends the third composition policy to the SF main thread.

Specifically, after receiving the third query request, the HWC thread may determine, based on a capability of the HWC thread and layer information of a layer other than the first layer in the to-be-composited layers, a composition manner of the layer other than the first layer in the to-be-composited layers. Further, composition manners of all the to-be-composited layers, for example, the third composition policy, may be obtained. In the third composition policy, a composition manner of the first layer is GPU composition.

S924 and S925 are performed after S922.

S923. In response to the second composition indication, the SF composition thread controls the GPU to composite the first layer to obtain the intermediate layer.

Specifically, the SF composition thread uses the GPU to composite the first layer, and may specifically control the GPU to fuse layer content of all the first layers into the first intermediate buffer based on layer information of the first layers. The first intermediate buffer includes layer content of the intermediate layer. The intermediate layer obtained by compositing the first layer in S923 may be referred to as a first intermediate layer.

After obtaining the intermediate layer, the SF composition thread may notify the SF main thread of this case, so that the main thread performs a subsequent composition procedure. Specifically, after obtaining the intermediate layer through composition, the SF composition thread may send a composition completion indication to the SF main thread, for example, perform S923A.

For specific implementations of S921 and S923, refer to the related descriptions of S918 and S919 in the foregoing embodiments. Details are not described herein again.

S923A. The SF composition thread sends the composition completion indication to the SF main thread.

The composition completion indication is used to indicate that composition of the intermediate layer is completed.

In practice, according to a specific synchronization method, when GPU composition and composition policy query are performed in parallel, time consumed by the HWC for returning the composition policy to the SF main thread may be the same as time consumed by the SF composition thread for obtaining the intermediate layer by using GPU composition and notifying the SF main thread of the intermediate layer. For example, step S923A and step S922 are completed at the same time. Alternatively, after either of step S923A and step S922 is completed, a subsequent procedure is performed only after the other step is completed.

In this case, the intermediate layer composited by the SF composition thread is obtained by compositing the first layer by using the GPU, and whether another layer that needs to be composited by the GPU still exists in the to-be-composited layers is not determined. Therefore, after obtaining the third composition policy and the identifier of the intermediate layer, the SF main thread further needs to determine whether a layer that needs to be composited by the GPU still exists in layers other than the first layer in the to-be-composited layers. This may be obtained by determining whether a to-be-composited layer other than the first layer exists in to-be-composited layers whose composition manners indicated by the third composition policy is GPU composition. For example, step S925 needs to be performed after both S923A and S922.

S924. The SF main thread receives the third composition policy from the HWC thread, and stores the hash value of the current frame and the third composition policy.

After storing the hash value of the current frame and the third composition policy, the SF may use the hash value of the current frame and the third composition policy as a hash value of a previous frame and a composition policy of the previous frame in a layer composition procedure in a next frame of image.

S925. The SF main thread determines, based on the third composition policy, whether a fourth layer exists in all the to-be-composited layers.

The fourth layer is a to-be-composited layer other than the first layer in the to-be-composited layers whose composition manners indicated by the third composition policy is GPU composition, for example, the fourth layer and the first layer are different to-be-composited layers. In this disclosure, the fourth layer may be referred to as a third target layer.

If it is determined, based on the third composition policy, that the fourth layer does not exist in the to-be-composited layers, it indicates that a to-be-composited layer that needs to be composited by the GPU in all the to-be-composited layers of the current frame includes only the first layer, and has been sent to the SF composition thread for composition. Herein, the SF main thread does not need to perform another action, and only needs to control the HWC to perform final layer composition and send-for-display. Then, S936 is performed. In this disclosure, that the fourth layer does not exist in the to-be-composited layers may be referred to as follows: Composition manners of all second target layers are HWC composition. The second target layers are to-be-composited layers other than the first target layers in the to-be-composited layers.

If it is determined, based on the third composition policy, that the fourth layer exists in the to-be-composited layers, it indicates that in addition to the first layer, the fourth layer that needs to be composited by the GPU further exists in all the to-be-composited layers of the current frame. In this case, the SF main thread may send layer information of the fourth layer to the SF composition thread, so that the SF composition thread uses the GPU to update the intermediate layer composited from the first layer. For example, step S926 is performed. In this disclosure, that the fourth layer exists in the to-be-composited layers may be referred to as follows: A third target layer whose composition manner is GPU composition exists in the second target layers.

It should be noted that there is no inevitable sequence between S924 and S925. S924 may be first performed, S925 may be first performed, or S924 and S925 may be simultaneously performed.

S926. The SF main thread sends a third composition indication to the SF composition thread.

The third composition indication carries layer information of all fourth layers, and the third composition indication is used to indicate to composite the fourth layer and the intermediate layer in the first intermediate buffer.

After receiving the third composition indication from the SF main thread, the SF composition thread can control the GPU to composite the fourth layer into the intermediate layer composited from the first layer to obtain an updated intermediate layer, for example, perform S927.

S927. In response to the third composition indication, the SF composition thread controls the GPU to composite the fourth layer into the intermediate layer obtained by compositing the first layer.

Specifically, the SF composition thread may control the GPU to fuse layer content of the fourth layer with layer content of the intermediate layer in the first intermediate buffer based on the layer information of the fourth layer, to update the layer content of the intermediate layer that is in the first intermediate buffer and that is obtained by compositing the first layer.

For specific implementations of S926 and S927, refer to the related descriptions of S918 and S919 in the foregoing embodiments. Details are not described herein again. In this way, all layers that cannot be composited by the HWC can be successfully composited by the GPU, so that it is ensured that final composition and send-for-display can be successfully completed by the HWC.

In some embodiments, when updating the intermediate layer, the SF may select a new empty buffer as a second intermediate buffer, and place the updated intermediate layer in the second intermediate buffer. In this case, the third composition indication in S926 is used to indicate to place, in the second intermediate buffer, a new intermediate layer (which specifically refers to layer content of the new intermediate layer) obtained after the fourth layer and the intermediate layer in the intermediate buffer are composited. S927 may be specifically as follows: Based on the layer information of the fourth layer, the SF composition thread fuses the layer content of the fourth layer with the layer content of the intermediate layer in the first intermediate buffer by using the GPU, and then places fused layer content of the new intermediate layer in the second intermediate buffer.

In this embodiment, S926 may specifically include: The SF main thread selects an empty buffer from the bufferqueue as the second intermediate buffer, and sends the third composition indication to the SF composition thread. During implementation, S927 may include: In response to the third composition indication, the SF composition thread invokes a first preset function to invoke the GPU to composite the fourth layer and the intermediate layer in the first intermediate buffer, and places layer content of a composited layer in the second intermediate buffer. The SF composition thread invokes a second preset function to obtain a predetermined mark.

After updating the intermediate layer, the SF composition thread may notify the SF main thread of an update completion status of the intermediate layer (or referred to as a composition completion status of the intermediate layer), so that the SF main thread performs a subsequent composition procedure. For example, S935 is performed.

S928. The SF main thread sends a fourth composition indication to the SF composition thread.

The fourth composition indication carries the layer information of all the second layers, and the fourth composition indication is used to indicate to place an intermediate layer composited from the second layer in the first intermediate buffer.

After receiving the fourth composition indication from the SF main thread, the SF composition thread may control the GPU to composite all the first layers to obtain an intermediate layer, for example, perform S930.

S929. In response to the first query request, the HWC thread determines a first composition policy, and sends the first composition policy to the SF main thread.

Specifically, after receiving the first query request, the HWC thread may determine, based on a capability of the HWC thread and layer information of a layer other than the second layer in the to-be-composited layers, a composition manner of the layer other than the second layer in the to-be-composited layers. Further, composition manners of all the to-be-composited layers, for example, the first composition policy, may be obtained. In the first composition policy, a composition manner of the second layer is GPU composition.

S931 and S932 are performed after S929.

S930. In response to the fourth composition indication, the SF composition thread controls the GPU to composite the second layer to obtain the intermediate layer.

Specifically, the SF composition thread controls the GPU to composite the second layer, and may specifically control the GPU to use the GPU to fuse layer content in a buffer of all second layers into the first intermediate buffer based on layer information of the second layers. In this case, a layer in the first intermediate buffer is an intermediate layer.

After obtaining the intermediate layer, the SF composition thread may notify the SF main thread of this case, so that the main thread performs a subsequent composition procedure. Specifically, after obtaining the intermediate layer through composition, the SF composition thread may send a composition completion indication to the SF main thread, for example, perform S930A.

For specific implementations of S928 and S930, refer to the related descriptions of S918 and S919 in the foregoing embodiments. Details are not described herein again.

S930A. The SF composition thread sends the composition completion indication to the SF main thread.

In practice, according to a specific synchronization method, when GPU composition and composition policy query are performed in parallel, time consumed by the HWC for returning the composition policy to the SF main thread may be the same as time consumed by the SF composition thread for obtaining the intermediate layer by using GPU composition and notifying the SF main thread of the intermediate layer. For example, step S930A and step S929 are completed at the same time. Alternatively, after either of step S930A and step S929 is completed, a subsequent procedure is performed only after the other step is completed.

In this case, the intermediate layer composited by the SF composition thread is obtained by compositing the second layer by using the GPU, and whether another layer that needs to be composited by the GPU still exists in the to-be-composited layers is not determined. Therefore, after obtaining the first composition policy and the identifier of the intermediate layer, the SF main thread further needs to determine whether a layer that needs to be composited by the GPU still exists in layers other than the second layer in the to-be-composited layers. This may be obtained by determining whether the first composition policy is the same as the composition policy of the previous frame. For example, step S932 needs to be performed after both step S930A and step S929.

S931. The SF main thread receives the first composition policy from the HWC thread, and stores the hash value of the current frame and the first composition policy.

After storing the hash value of the current frame and the first composition policy, the SF may use the hash value of the current frame and the first composition policy as a hash value of a previous frame and a composition policy of the previous frame in a layer composition procedure in a next frame of image.

S932. The SF main thread determines whether the first composition policy is the same as the composition policy of the previous frame.

If it is determined that the first composition policy is the same as the composition policy of the previous frame, it indicates that all layers that need to be composited by the GPU in all the to-be-composited layers in the current frame have been sent to the SF composition thread for composition. In this case, the SF main thread does not need to perform another action, and only needs to indicate the HWC to perform final layer composition and send-for-display. Then, S936 is performed.

If it is determined that the first composition policy is different from the composition policy of the previous frame of image, it indicates that in addition to the second layer, a fifth layer that needs to be composited by the GPU may further exist in all the to-be-composited layers in the current frame. In this case, the SF main thread may send layer information of the fifth layer to the SF composition thread, so that the SF composition thread uses the GPU to update an intermediate layer composited from the second layer. For example, step S933 is performed.

It should be noted that there is no inevitable sequence between S931 and S932. S931 may be first performed, S932 may be first performed, or S931 and S932 may be simultaneously performed.

S933. The SF main thread sends a fifth composition indication to the SF composition thread.

The fifth composition indication carries layer information of all fifth layers, and the fifth composition indication is used to indicate to composite the fifth layer and the intermediate layer in the first intermediate buffer.

The fifth layer is a layer other than the second layer in layers whose composition manners in the first composition policy are GPU composition.

After receiving the layer information of all the fifth layers from the SF main thread, the SF composition thread may control the GPU to update, by using the fifth layer, the intermediate layer composited from the second layer, to obtain a latest intermediate layer. For example, S934 is performed.

S934. In response to the fifth composition indication, the SF composition thread controls the GPU to update, by using the fifth layer, the intermediate layer obtained by compositing the second layer.

Specifically, the SF composition thread controls the GPU to update, by using the fifth layer, the intermediate layer obtained by compositing the second layer, and may specifically control the GPU to fuse layer content of the fifth layer with layer content of the intermediate layer in the first intermediate buffer based on the layer information of the fifth layer, to update the layer content of the intermediate layer that is in the first intermediate buffer and that is obtained by compositing the second layer.

In some embodiments, when updating the intermediate layer, the SF may select a new empty buffer as a second intermediate buffer, and place the updated intermediate layer in the second intermediate buffer. In this case, the fifth composition indication in S933 is used to indicate to place, in the second intermediate buffer, a new intermediate layer (which specifically refers to layer content of the new intermediate layer) obtained after the fifth layer and the intermediate layer in the first intermediate buffer are composited. S934 may be specifically as follows: Based on the layer information of the fifth layer, the SF composition thread controls the GPU to fuse the layer content of the fourth layer with the layer content of the intermediate layer in the first intermediate buffer, and then places fused layer content of the new intermediate layer in the second intermediate buffer.

For specific implementations of S933 and S934, refer to the related descriptions of S926 and S928 in the foregoing embodiment. Details are not described herein again.

After updating the intermediate layer, the SF composition thread may notify the SF main thread of an update completion status of the intermediate layer, so that the SF main thread performs a subsequent composition procedure. For example, S935 is performed.

S935. The SF composition thread sends the composition completion indication to the SF main thread.

S936 is performed after S935.

S936. The SF main thread sends a composition instruction to the HWC thread.

The composition instruction carries an identifier of the intermediate layer, and the composition instruction is used to instruct the HWC to composite the intermediate layer and a layer whose composition manner in a final composition policy is HWC composition, and send a composited layer for display. The final composition policy may be the first composition policy, the second composition policy, or the third composition policy.

If S935 is performed before S936, and S919 is performed before S935, the final composition policy is the second composition policy. If S932 is performed before S936, or S934 and S935 are successively performed before S936, the final composition policy is the first composition policy. If S925 is performed before S936, or S925 and S935 are performed at a time before S936, the final composition policy is the third composition policy.

In some embodiments, the composition instruction may further carry layer information of all layers whose composition manners in the final composition policy are HWC composition.

There are five cases of the composition completion indication during execution of S935.

A first case is a composition completion indication sent by the SF composition thread to the SF main thread when S935 is performed after S919 is performed. A second case is a composition completion indication sent by the SF composition thread to the SF main thread when S923A is performed. A third case is a composition completion indication sent by the SF composition thread to the SF main thread when S935 is performed after S927 is performed. A fourth case is a composition completion indication sent by the SF composition thread to the SF main thread when S930A is performed. A fifth case is a composition completion indication sent by the SF composition thread to the SF main thread when S935 is performed after S934 is performed.

In the third case and the fifth case, when updating the intermediate layer, the SF composition thread places an updated intermediate layer in the second intermediate buffer. In this case, the identifier of the intermediate layer may be an identifier of the second intermediate buffer. In the other cases, the identifier of the intermediate layer is an identifier of the first intermediate buffer.

S937. In response to the composition instruction, the HWC thread composites the intermediate layer and a to-be-composited layer whose composition manner indicated by the final composition policy is HWC composition, to obtain an image of the current frame, and send the image for display.

After receiving the composition instruction, the HWC thread may fuse layer content of a sixth layer with the layer content of the intermediate layer based on layer information of the sixth layer, to obtain the image of the current frame.

In some embodiments, composition performed by the HWC thread on the intermediate layer and the sixth layer may be completed by using a DPU. Specifically, the HWC thread may send the layer information of the sixth layer and the identifier of the intermediate layer to a display driver, and the display driver may control the DPU to composite the intermediate layer and the sixth layer when a latest tearing effect (TE) signal is generated, to obtain the image of the current frame. Then, the display driver may send the image of the current frame to an integrated circuit (IC) for display.

After the HWC thread completes layer composition and send-for-display, to make layer composition in a next frame smoothly performed, S938 may be further performed after S937.

S938. After completing send-for-display, the HWC thread returns a send-for-display completion indication to the SF main thread.

In this way, the SF can determine that composition of a layer in the next frame can be performed. For example, the send-for-display completion indication may include releaseFence.

In some embodiments, after completing composition of all layers, the HWC thread may further return a composition end indication to the SF main thread, where the composition end indication is used to indicate that all the layers have been composited. For example, the composition end indication may include retireFence.

In some other embodiments, the SF main thread further performs corresponding post-processing when the SF main thread receives the send-for-display completion indication and the composition end indication from the HWC. Specifically, the SF main thread performs callback callback for send-for-display completion monitored by an application, for example, returns an indication message indicating send-for-display completion to an application corresponding to all the to-be-composited layers of the current frame. In addition, the SF main thread may further update timestamp parameters of all the to-be-composited layers to determine the latest composition and send-for-display time of all the to-be-composited layers. Finally, if a buffer of a to-be-composited layer is not consumed for various possible reasons, for example, the to-be-composited layer is not composited, it may be indicated to process the to-be-composited layer when a next Vsync-SF signal arrives.

Based on the technical solution provided in this embodiment of this disclosure, if all to-be-composited layers of the current frame do not meet a parallel condition (a hash value of the current frame is different from a hash value of the previous frame), when a special layer that meets the preset condition exists, GPU composition and composition policy query may be performed in parallel, to reduce time required for layer composition, and reduce a frame loss problem caused by excessively long layer composition time, so that a display effect of a dynamic picture is smoother, and user experience is improved.

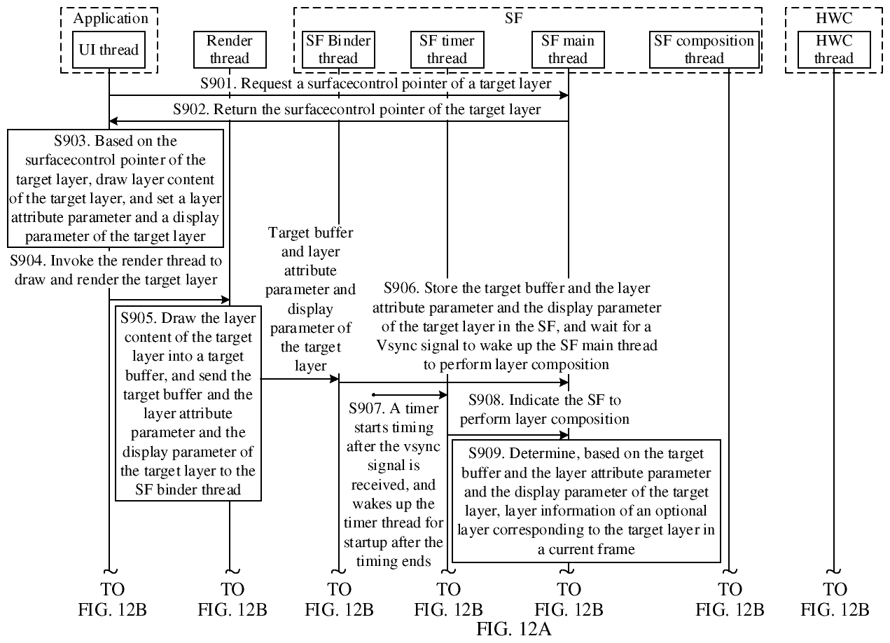

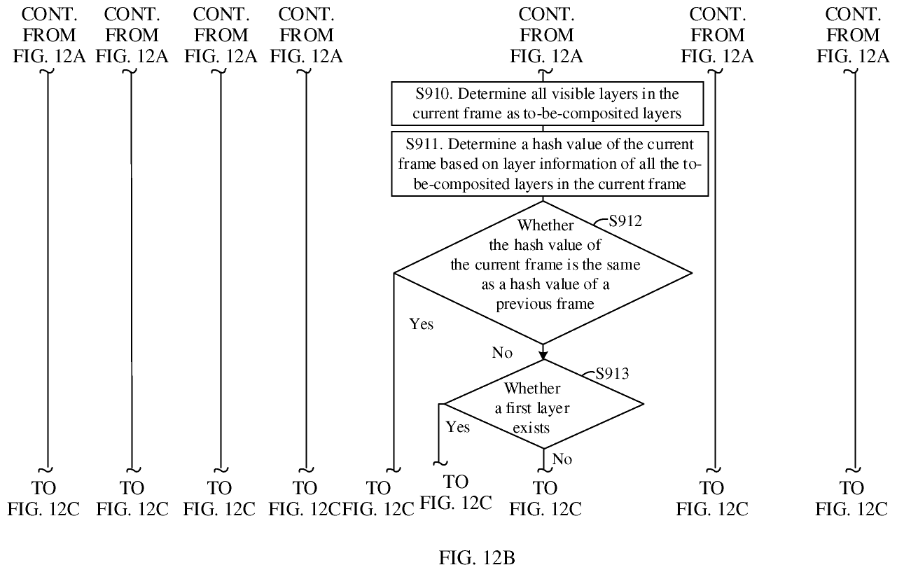

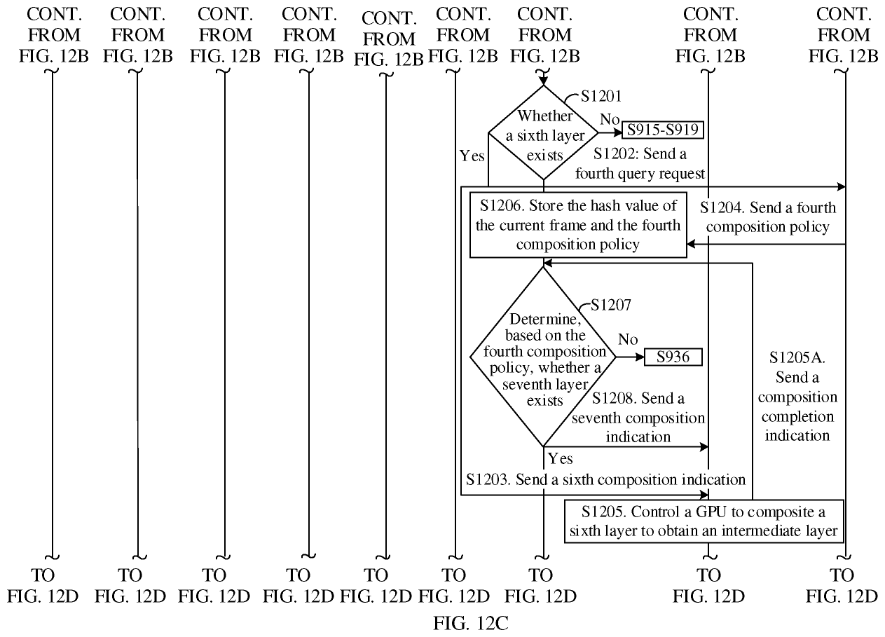

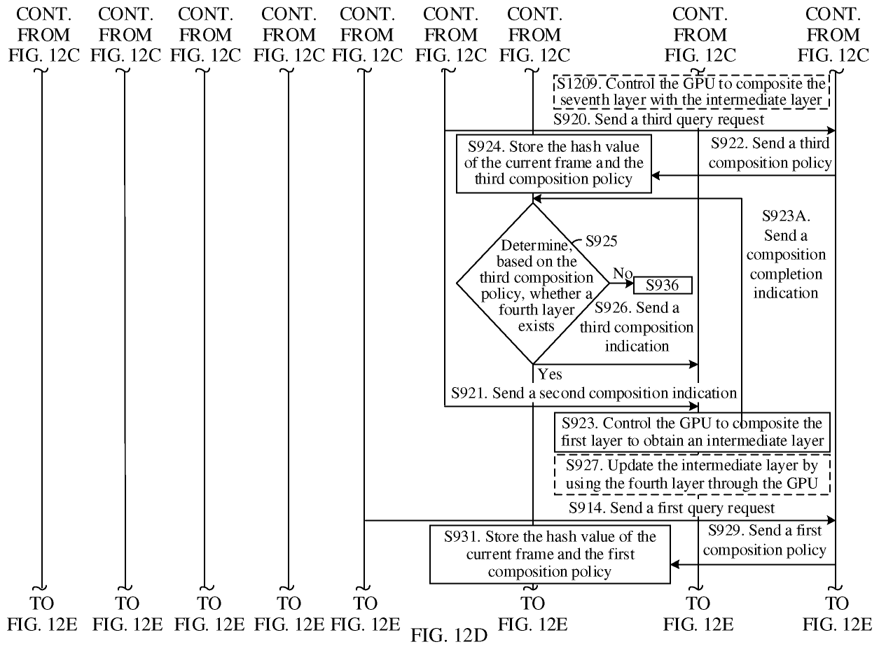

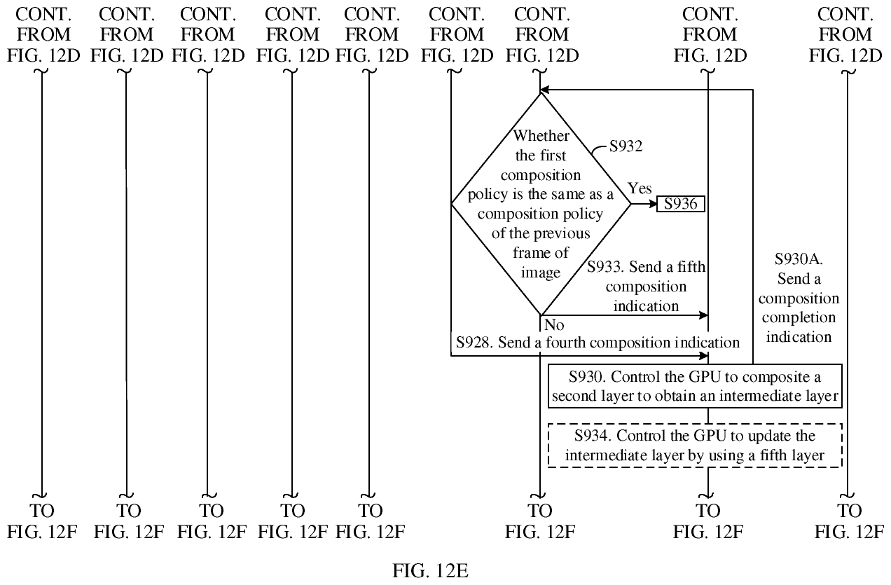

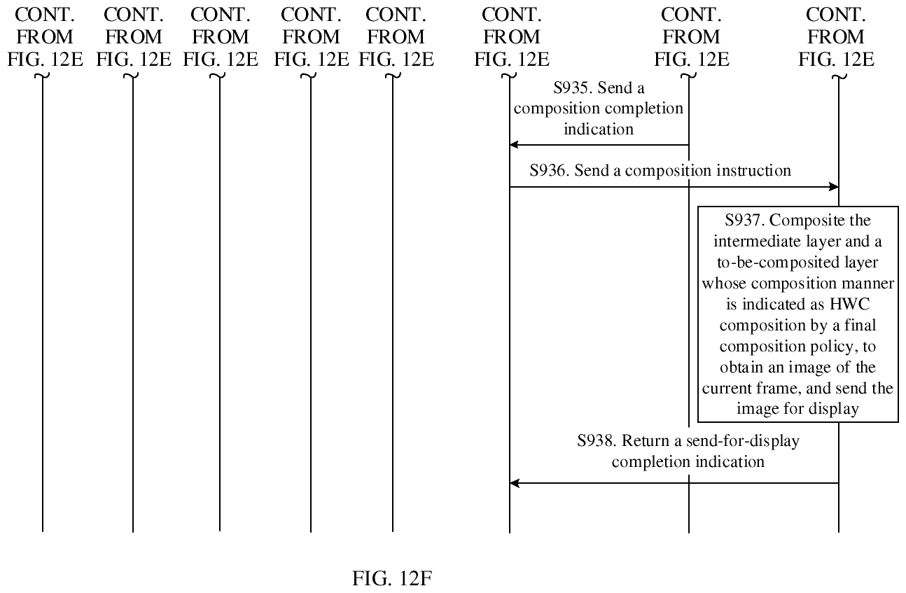

In some embodiments, when the SF main thread determines that the hash value of the current frame is different from the hash value of the previous frame, if it is determined that no first layer that meets the preset condition exists in all the to-be-composited layers of the current frame, to improve layer composition efficiency and reduce layer composition time, the electronic device may directly perform GPU composition forcibly on a layer that is in all the to-be-composited layers of the current frame and whose composition manner is GPU composition in the composition policy in the previous frame, and query a composition policy, so as to implement parallel execution of GPU composition and composition policy query. Based on this, with reference to FIG. 9A to FIG. 9E, as shown in FIG. 12A to FIG. 12F, after S913 is performed, when it is determined that no first layer that meets the preset condition exists in all the to-be-composited layers of the current frame, the method further includes S1201-S1209.

S1201. The SF main thread determines whether a sixth layer exists in all the to-be-composited layers of the current frame.

The sixth layer is a layer whose composition manner is GPU composition in the composition policy in the previous frame. For example, if the composition policy in the previous frame indicates that a composition manner of a layer B (B may be a name of the layer) is GPU composition, the layer B is the sixth layer. In this disclosure, the sixth layer may be referred to as a fourth target layer.

When determining that the sixth layer does not exist in all the to-be-composited layers of the current frame, the SF main thread needs to perform composition policy query and GPU composition in series, for example, sequentially perform S915-S919. FIG. 12A to FIG. 12F do not show specific content of S915-S919. For specific content and implementations, refer to FIG. 9A to FIG. 9E and related descriptions in FIG. 9A to FIG. 9E. Details are not described herein again.

When determining that the sixth layer exists in all the to-be-composited layers of the current frame, the electronic device may perform GPU composition and composition policy query in parallel. Specifically, the SF main thread may deliver the sixth layer to the GPU for composition (which may be specifically controlling the GPU to composite the sixth layer to obtain a second intermediate layer), and control the HWC to query a composition policy (which may be specifically controlling the HWC to query a composition manner of the to-be-composited layer). In this case, S1202 and S1203 are started at the same time.

S1202. The SF main thread sends a fourth query request to the HWC thread.

The fourth query request carries the layer information of all the to-be-composited layers, and indicates that a composition manner of the sixth layer is GPU composition. Specifically, an implementation of indicating that the composition manner of the sixth layer is GPU composition may be adding the first mark to the layer information of the sixth layer. The fourth query request is used to request to query a composition policy.

In some embodiments, the first mark may be added by the SF main thread to the layer information of the sixth layer before S1202 and after S1201 in a case in which it is determined that the sixth layer exists.

After receiving the fourth query request from the SF main thread, the HWC thread may obtain a fourth query policy based on the request and return the fourth query policy to the SF main thread. For example, S1204 is performed after S1202.

S1203. The SF main thread sends a sixth composition indication to the SF composition thread.

The sixth composition indication carries layer information of all sixth layers, and the sixth composition indication is used to indicate to composite the sixth layer into the first intermediate buffer.

After receiving the layer information of all the sixth layers from the SF main thread, the SF composition thread may control the GPU to composite all the sixth layers to obtain an intermediate layer, for example, perform S1205.

S1204. In response to the fourth query request, the HWC thread determines a fourth composition policy, and sends the fourth composition policy to the SF main thread.

Specifically, after receiving the fourth query request, the HWC thread may determine, based on a capability of the HWC thread and layer information of a layer other than the sixth layer in the to-be-composited layers, a composition manner of the layer other than the sixth layer in the to-be-composited layers. Further, composition manners of all the to-be-composited layers, for example, the fourth composition policy, may be obtained. In the fourth composition policy, a composition manner of the sixth layer is GPU composition.

S1206 and S1207 are performed after S1204.

S1205. In response to the sixth composition indication, the SF composition thread controls the GPU to composite the sixth layer to obtain the intermediate layer.

For a specific implementation of S1205, refer to the related descriptions of S923 in the foregoing embodiment. Details are not described herein again. In this disclosure, the intermediate layer obtained by compositing the sixth layer in S1205 may be referred to as a second intermediate layer.

After obtaining the intermediate layer, the SF composition thread may notify the SF main thread of this case, so that the main thread performs a subsequent composition procedure. Specifically, after obtaining the intermediate layer through composition, the SF composition thread may send a composition completion indication to the SF main thread, for example, perform S1205A.

S1205A. The SF composition thread sends the composition completion indication to the SF main thread.

The composition completion indication is used to indicate that composition of the intermediate layer is completed.

In practice, according to a specific synchronization method, when GPU composition and composition policy query are performed in parallel, time consumed by the HWC for returning the composition policy to the SF main thread may be the same as time consumed by the SF composition thread for obtaining the intermediate layer by using GPU composition and notifying the SF main thread of the intermediate layer. For example, step S1205A and step S1204 are completed at the same time. Alternatively, after either of step S1205A and step S1204 is completed, a subsequent procedure is performed only after the other step is completed.

In this case, the intermediate layer composited by the SF composition thread is obtained by compositing the sixth layer by using the GPU, and whether another layer that needs to be composited by the GPU still exists in the to-be-composited layers is not determined. Therefore, after obtaining the fourth composition policy and the identifier of the intermediate layer, the SF main thread further needs to determine whether a layer that needs to be composited by the GPU still exists in layers other than the sixth layer in the to-be-composited layers. This may be obtained by determining whether a layer other than the sixth layer exists in layers whose composition manners indicated by the fourth composition policy is GPU composition. For example, step S1207 needs to be performed after both S1205A and S1204.

S1206. The SF main thread receives the fourth composition policy from the HWC thread, and stores the hash value of the current frame and the fourth composition policy.

After storing the hash value of the current frame and the fourth composition policy, the SF may use the hash value of the current frame and the fourth composition policy as a hash value of a previous frame and a composition policy of the previous frame in a layer composition procedure in a next frame of image.

S1207. The SF main thread determines, based on the fourth composition policy, whether a seventh layer exists in all the to-be-composited layers.

The seventh layer is a to-be-composited layer other than the sixth layer in the to-be-composited layers whose composition manners indicated by the fourth composition policy is GPU composition, for example, the sixth layer and the seventh layer are different to-be-composited layers. In this disclosure, the seventh layer may be referred to as a sixth target layer.

If it is determined, based on the fourth composition policy, that the seventh layer does not exist in all the to-be-composited layers, it indicates that a to-be-composited layer that needs to be composited by the GPU in all the to-be-composited layers of the current frame includes only the sixth layer, and has been sent to the SF composition thread for composition. Herein, the SF main thread does not need to perform another action, and only needs to indicate the HWC to perform final layer composition and send-for-display. Then, S936 is performed. In this disclosure, that the seventh layer does not exist in the to-be-composited layers may be referred to as follows: Composition manners of all fifth target layers are HWC composition. The fifth target layers are to-be-composited layers other than the fourth target layers in the to-be-composited layers.

If it is determined, based on the fourth composition policy, that the seventh layer exists in all the to-be-composited layers, it indicates that in addition to the sixth layer, the seventh layer that needs to be composited by the GPU further exists in all the to-be-composited layers of the current frame. In this case, the SF main thread may send layer information of the seventh layer to the SF composition thread, so that the SF composition thread uses the GPU to update, by using the seventh layer, the intermediate layer composited from the sixth layer. For example, step S1208 is performed. In this disclosure, that the seventh layer exists in the to-be-composited layers may be referred to as follows: A sixth target layer whose composition manner is GPU composition exists in the fifth target layers.

It should be noted that there is no inevitable sequence between S1206 and S1207. S1206 may be first performed, S1207 may be first performed, or S1206 and S1207 may be simultaneously performed.

S1208. The SF main thread sends a seventh composition indication to the SF composition thread.

The seventh composition indication carries layer information of all seventh layers, and the seventh composition indication is used to indicate to composite the seventh layer and the intermediate layer in the first intermediate buffer.

The seventh layer is a layer other than the sixth layer in layers whose composition manners in the fourth composition policy are GPU composition.

After receiving the seventh composition indication from the SF main thread, the SF composition thread can control the GPU to composite the seventh layer into the intermediate layer composited from the sixth layer to obtain an updated intermediate layer, for example, perform S1209.

S1209. In response to the seventh composition indication, the SF composition thread controls the GPU to composite the seventh layer into the intermediate layer obtained by compositing the sixth layer.

In this disclosure, the intermediate layer obtained by compositing the seventh layer into the intermediate layer obtained by compositing the sixth layer may be referred to as an updated second intermediate layer.

For specific implementations of S1208 and S1209, refer to the related descriptions of S926 and S927 in the foregoing embodiments. Details are not described herein again. Based on the technical solution corresponding to S1209, a to-be-composited layer that cannot be composited by the HWC can be successfully composited by the GPU, so that layer composition efficiency is improved, and it is ensured that final composition and send-for-display can be successfully completed by the HWC.

In the foregoing technical solution, the final composition policy in S937 may alternatively be the fourth composition policy. If S1207 is performed before S936, or S1209 and S935 are sequentially performed before S936, the final composition policy is the fourth composition policy.

Based on the foregoing technical solution corresponding to S1201-S1209, when the to-be-composited layers of the current frame do not meet the parallel condition (the hash value of the current frame is different from the hash value of the previous frame), and no special layer that meets the preset condition exists, if a special layer on which GPU composition is performed in the previous frame exists, the electronic device may perform GPU composition and composition policy query in parallel, to reduce time required for layer composition, and reduce a frame loss problem caused by excessively long layer composition time, so that a display effect of a dynamic picture is smoother, and user experience is improved.

Generally, to avoid a complex update operation in a historical buffer of a layer (which is a buffer generated for the layer during previous layer composition), and improve layer composition efficiency, in a process of performing layer composition, the electronic device usually generates a new buffer for the layer, instead of modifying the historical buffer of the layer. As a quantity of layer composition times increases, there are more historical buffers for a same layer, and pressure on a memory is increasingly high. Based on this, in some embodiments, to reduce the memory pressure, when querying a composition policy, the HWC further determines, based on layer information of a to-be-composited layer, whether a historical buffer needs to be cleared for the to-be-composited layer. For example, all composition policies (the first composition policy, the second composition policy, the third composition policy, and the fourth composition policy) may further include a clear indication for each to-be-composited layer. The clear indication is used to indicate to clear a historical buffer of the layer or not to clear a historical buffer of the layer. After receiving the composition policy, the SF main thread clears content in a historical buffer of a to-be-composited layer to which a target clear indication indicating to clear the historical buffer of the layer belongs, so that the historical buffer of the layer becomes an empty buffer in the bufferqueue.

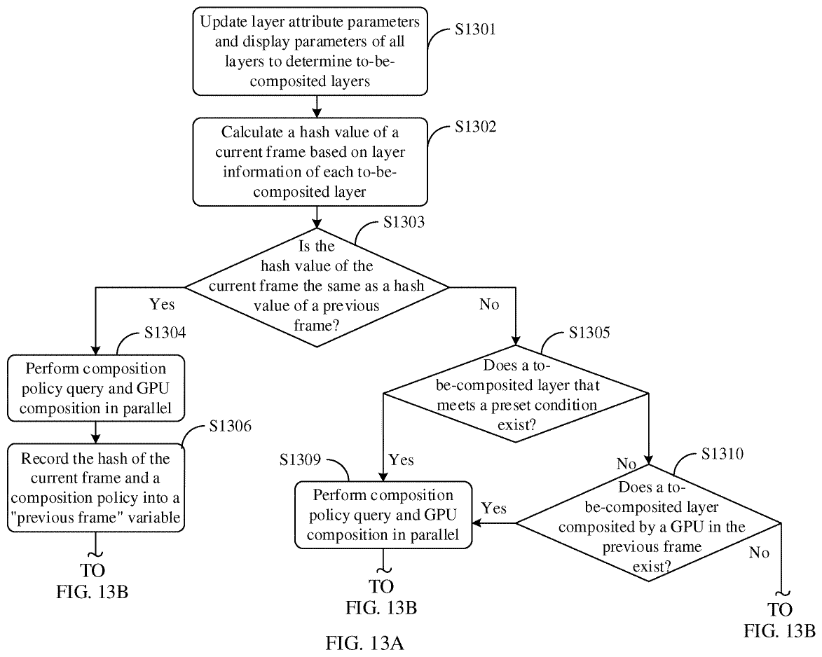

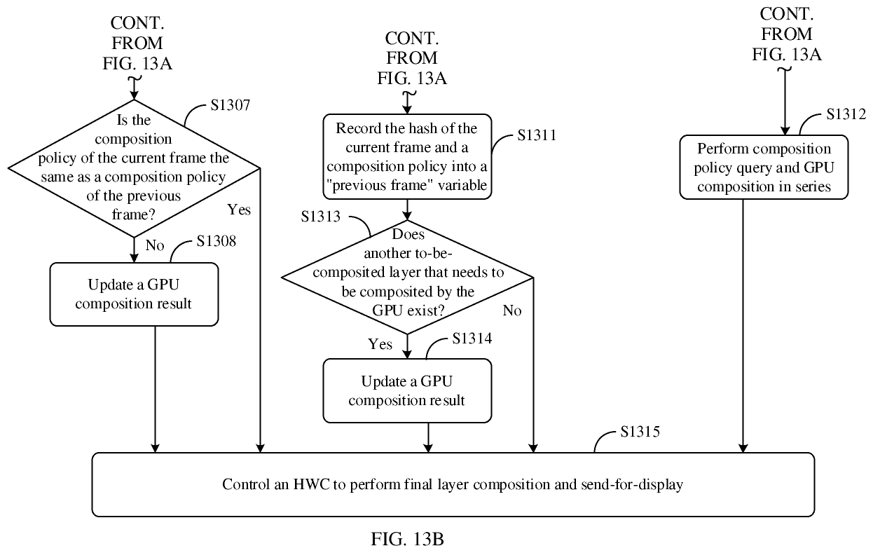

To describe a layer composition process of an electronic device more clearly, the following describes the layer composition process of the electronic device with reference to FIG. 13A and FIG. 13B. Referring to FIG. 13A and FIG. 13B, the process includes S1301-S1314.

S1301. Update layer attribute parameters and display parameters of all layers to determine to-be-composited layers of a current frame.

All the layers are all layers currently registered with an SF in the electronic device.

For a specific implementation of S1301, refer to the related descriptions of S901-S910 in the foregoing embodiment. Details are not described herein again.

S1302. Calculate a hash value of the current frame based on layer information of each to-be-composited layer.

The layer information may include an identifier or a pointer of a buffer corresponding to the layer, a layer attribute parameter, and a display parameter. The identifier or the pointer of the buffer corresponding to the layer may be specifically a handle of the buffer corresponding to the layer. For specific content of the layer attribute parameter and the display parameter, refer to related descriptions in the foregoing embodiments. Details are not described herein again.

For a specific implementation of S1302, refer to the related descriptions of S911 in the foregoing embodiment. Details are not described herein again.

S1303. Determine whether the hash value of the current frame is the same as a hash value of a previous frame.

When the hash value of the current frame is the same as a hash value of a previous frame, it may be considered that there is no change between a layer that needs to be displayed in the current frame and a layer that needs to be displayed in the previous frame. In this case, it is determined that a first detection result meets a parallel condition, and composition policy query and GPU composition may be performed in parallel, for example, S1304 is performed.

When the hash value of the current frame is different from a hash value of a previous frame, to perform composition policy query and GPU composition in parallel, whether a special layer that meets a preset condition exists in the to-be-composited layers may be first determined, for example, S1305 is performed.

S1304. Perform composition policy query and GPU composition in parallel.

S1304 may be specifically controlling an HWC to query a composition manner of the to-be-composited layer, and controlling a GPU to composite a to-be-composited layer whose composition manner in the previous frame is GPU composition in the to-be-composited layers.

For a specific implementation of S1304, refer to the related descriptions of S914, S928, S929, S930, and S930A in the foregoing embodiment. Details are not described herein again.

S1305. Determine whether a to-be-composited layer that meets a preset condition exists in the to-be-composited layers.

When a to-be-composited layer that meets the preset condition exists in the to-be-composited layers, it is determined that composition policy query and GPU composition can be performed in parallel, for example, S1309 can be performed.

When a to-be-composited layer that meets the preset condition exists in the to-be-composited layers, to perform composition policy query and GPU composition in parallel, whether a special layer whose composition manner in the previous frame is GPU composition exists in the to-be-composited layers may be further determined, for example, S1310 is performed.

For a specific implementation of S1305, refer to the related descriptions of S913 in the foregoing embodiment. Details are not described herein again.

S1306. Record the hash of the current frame and the composition policy into a “previous frame” variable.

For a specific meaning of the “previous frame” variable, refer to the related descriptions between S917 and S918 in the foregoing embodiment. Details are not described herein again.

For a specific implementation of S1306, refer to the related descriptions of S931 in the foregoing embodiment. Details are not described herein again.

S1307. Determine whether the composition policy of the current frame is the same as a composition policy of the previous frame.

When the composition policy of the current frame is the same as the composition policy of the previous frame, it is determined that all layers that need to be composited by the GPU in all the to-be-composited layers in the current frame have been composited by the GPU. In this case, no other action needs to be performed, and only the HWC needs to be controlled to perform final layer composition and send-for-display, for example, S1315 is performed.

When the composition policy of the current frame is different from the composition policy of the previous frame, it indicates that to-be-composited layers that need to be composited by the GPU still exist in all the to-be-composited layers in the current frame. In this case, these to-be-composited layers may be composited by the GPU, to update a GPU composition result obtained after S1304 is performed, for example, step S1308 is performed.

S1308. Update the GPU composition result.

For a specific implementation of S1308, refer to the related descriptions of S934 and S935 in the foregoing embodiment. Details are not described herein again.

S1315 is performed after S1308.

S1309. Perform composition policy query and GPU composition in parallel.

When S1309 is performed after S1305, for a specific implementation of S1309, refer to the related descriptions of S920, S922, S921, S923, and S923A in the foregoing embodiment. Details are not described herein again.

When S1309 is performed after S1310, for a specific implementation of S1309, refer to the related descriptions of S1202, S1204, S1203, S1205, and S1205A in the foregoing embodiment. Details are not described herein again.

S1310. Determine whether a to-be-composited layer composited by the GPU in the previous frame exists in the to-be-composited layers.

When a to-be-composited layer composited by the GPU in the previous frame exists in the to-be-composited layers, it is determined that composition policy query and GPU composition can be performed in parallel, for example, S1309 can be performed.

When a to-be-composited layer that meets the preset condition exists in the to-be-composited layers, to perform composition policy query and GPU composition in parallel, whether a special layer whose composition manner in the previous frame is GPU composition exists in the to-be-composited layers may be further determined, for example, S1310 is performed.

For a specific implementation of S1310, refer to the related descriptions of S913 in the foregoing embodiment. Details are not described herein again.

S1311. Record the hash of the current frame and the composition policy into a “previous frame” variable.

For a specific meaning of the “previous frame” variable, refer to the related descriptions between S917 and S918 in the foregoing embodiment. Details are not described herein again.

When S1309 is performed after S1305, for a specific implementation of S1311, refer to the related descriptions of S924 in the foregoing embodiment. Details are not described herein again.

When S1309 is performed after S1310, for a specific implementation of S1311, refer to the related descriptions of S1206 in the foregoing embodiment. Details are not described herein again.

S1312. Perform composition policy query and GPU composition in series.

S1312 is specifically first obtaining composition manners of the to-be-composited layers, and then controlling the GPU to composite a to-be-composited layer whose composition manner is GPU composition.

For a specific implementation of S1312, refer to the related descriptions of S915-S919 and S935 in the foregoing embodiment. Details are not described herein again.

S1315 is performed after S1312.

S1313. Determine whether a to-be-composited layer that needs to be composited by the GPU exists in the to-be-composited layers.

When no to-be-composited layer that needs to be composited by the GPU exists in the to-be-composited layers, it is determined that all layers that need to be composited by the GPU in all the to-be-composited layers in the current frame have been composited by the GPU. In this case, no other action needs to be performed, and only the HWC needs to be controlled to perform final layer composition and send-for-display, for example, S1315 is performed.

When a to-be-composited layer that needs to be composited by the GPU exists in the to-be-composited layers, it indicates that to-be-composited layers that need to be composited by the GPU still exist in all the to-be-composited layers in the current frame. In this case, these to-be-composited layers may be composited by the GPU, to update a GPU composition result obtained after S1309 is performed, for example, step S1314 is performed.

S1314. Update the GPU composition result.

When S1309 is performed after S1305, for a specific implementation of S1314, refer to the related descriptions of S927 and S935 in the foregoing embodiment. Details are not described herein again.

When S1309 is performed after S1310, for a specific implementation of S1314, refer to the related descriptions of S1209 in the foregoing embodiment. Details are not described herein again.

S1315. Control the HWC to perform final layer composition and send-for-display.

For a specific implementation of S1315, refer to the related descriptions of S936 and S937 in the foregoing embodiment. Details are not described herein again.

For beneficial effects of the embodiment corresponding to FIG. 13A and FIG. 13B, refer to the beneficial effects of the layer composition method provided in the foregoing embodiments. Details are not described herein again.

It may be understood that to implement the foregoing functions, the electronic device includes corresponding hardware structures and/or software modules for performing the functions. A person skilled in the art should easily realize that, with reference to the units and algorithm steps described in the embodiments disclosed in this specification, the embodiments of the present disclosure can be implemented in a form of hardware or hardware and computer software. Whether a specific function is performed by hardware or hardware driven by computer software depends on a particular application and a design constraint of the technical solutions. A person skilled in the art may use different methods to implement the described functions for each particular application, but it should not be considered that the implementation goes beyond the scope of the embodiments of this disclosure.

In the embodiments of this disclosure, the foregoing electronic device may be divided into functional modules based on the foregoing method examples. For example, each functional module may be obtained through division for a corresponding function, or two or more functions may be integrated into one processing module. The integrated module may be implemented in a form of hardware, or may be implemented in a form of a software functional module. It should be noted that division into modules in the embodiments of the present disclosure is an example, and is merely logical function division. During actual implementation, there may be another division manner.

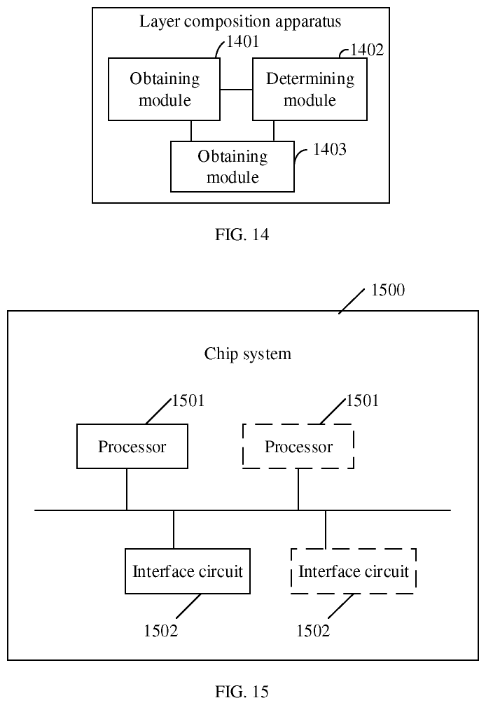

When functional modules are divided by corresponding functions, referring to FIG. 14, an embodiment of this disclosure further provides a layer composition apparatus, and the apparatus may be used in an electronic device. The electronic device may include an obtaining module 1401, a determining module 1402, and a control module 1403.

The obtaining module 1401 is configured to obtain layer information of to-be-composited layers in a current frame. The determining module 1402 is configured to determine a first detection result based on the layer information of the to-be-composited layers that is obtained by the obtaining module 1401. The control module 1403 is configured to: when the first detection result determined by the determining module 1402 does not meet a first condition, and first target layers that meet a preset condition exist in the to-be-composited layers obtained by the obtaining module 1401, control a GPU to composite the first target layers to obtain a first intermediate layer, and control an HWC to query a composition manner of the to-be-composited layers, where a composition manner of the first target layers that meet the preset condition is GPU composition, and the preset condition includes any one or more of the following: a layer attribute parameter or a display parameter of a layer changes; a layer is a newly added layer, a layer attribute parameter includes a first mark, and the first mark is used to indicate to use the GPU for composition; a layer is a newly added layer, and a buffer size of the layer is greater than a preset size; a composition manner of a layer in a previous frame is GPU composition, and a position of the layer changes or a visible area of the layer becomes larger; or a position of a layer is rotated 180° compared with that in a previous frame. The control module 1403 is further configured to: when composition manners of all second target layers are HWC composition, control the HWC to composite the first intermediate layer and the second target layers to obtain an image of the current frame, where the second target layers are to-be-composited layers other than the first target layers in the to-be-composited layers.

In addition, cooperation between the obtaining module 1401, the determining module 1402, and the control module 1403 may further enable the layer composition apparatus to complete all steps in the layer composition method provided in the foregoing embodiments.

For a specific manner in which each module of the layer composition apparatus in the foregoing embodiment performs an operation is described in detail in the embodiment of the layer composition method in the foregoing embodiments, and details are not described herein again. For related beneficial effects, refer to related beneficial effects of the foregoing layer composition method. Details are not described herein again.

An embodiment of this disclosure further provides an electronic device. The electronic device includes a display, a memory, and one or more processors. The display and the memory are coupled to the processor. The memory stores computer program code, the computer program code includes computer instructions, and when the computer instructions are executed by the processor, the electronic device is enabled to perform the layer composition method provided in the foregoing embodiments. For a specific structure of the electronic device, refer to the structure of the electronic device shown in FIG. 7.

An embodiment of this disclosure further provides a computer-readable storage medium. The computer-readable storage medium includes computer instructions, and when the computer instructions are run on an electronic device, the electronic device is enabled to perform the layer composition method provided in the foregoing embodiments.

An embodiment of this disclosure further provides a chip system. As shown in FIG. 15, the chip system 1500 includes at least one processor 1501, a memory, and at least one interface circuit 1502. The processor 1501 and the interface circuit 1502 may be connected to each other through a line. For example, the interface circuit 1502 may be configured to receive a signal from another apparatus (for example, a network side device). For another example, the interface circuit 1502 may be configured to send a signal to another apparatus (for example, a network side device).

For example, the interface circuit 1502 may read instructions or a computer program stored in the memory, and send the instructions or the computer program to the processor 1501. When the instructions or the computer program is executed by the processor 1501, steps of the layer control method provided in the foregoing embodiments may be implemented. Certainly, the chip system may further include another discrete device. This is not specifically limited in this embodiment of this disclosure.

An embodiment of this disclosure further provides a computer program product. The computer program product includes executable instructions. When the computer program product runs on an electronic device, the electronic device is enabled to perform the layer composition method provided in the foregoing embodiments.

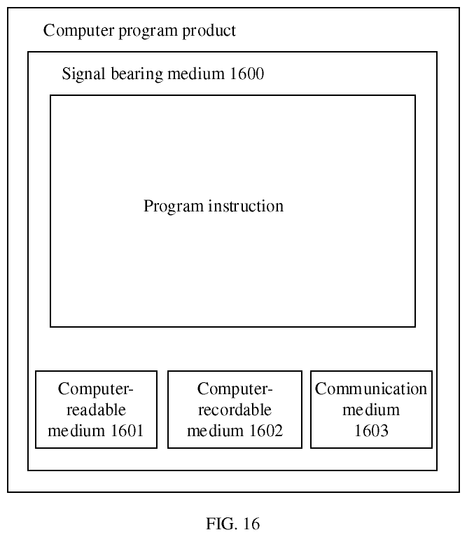

FIG. 16 schematically shows a conceptual partial view of a computer program product according to an embodiment of the present disclosure. In an embodiment, the computer program product is provided by using a signal bearing medium 1600. The signal bearing medium 1600 may include one or more program instructions that may provide the foregoing functions or some functions described for FIG. 4 when being run by one or more processors. Therefore, for example, one or more features or steps of the layer composition method provided with reference to the foregoing embodiments may be borne by one or more instructions associated with the signal bearing medium 1600. In addition, the program instructions in FIG. 16 also describe example instructions.

In some examples, the signal bearing medium 1600 may include a computer-readable medium 1601, for example but not limited to, a hard disk drive, a compact disc (CD), a digital video disc (DVD), a digital tape, a memory, a read-only memory (ROM), or a random access memory (RAM).

In some implementations, the signal bearing medium 1600 may include a computer-recordable medium 1602, for example but not limited to, a memory, a read/write (R/W) CD, an R/W DVD, or the like.

In some implementations, the signal bearing medium 1600 may include a communication medium 1603, for example but not limited to, a digital and/or analog communication medium (for example, an optical fiber cable, a waveguide, a wired communication link, or a wireless communication link).

The signal bearing medium 1600 may be communicated by a wireless communication medium 1603 (for example, a wireless communication medium complying with the IEEE 802.150 standard or another transmission protocol). One or more program instructions may be, for example, computer-executable instructions or logic implementation instructions.

In some examples, a data write apparatus for receiving and storing external data may be further included, and may be configured to provide various operations, functions, or actions in response to one or more program instructions in the computer-readable medium 1601, the computer-recordable medium 1602, and/or the communication medium 1603.

It can be clearly learned by a person skilled in the art from the foregoing descriptions of the implementations that for convenience and brevity of description, only division into the foregoing functional modules is used as an example for description. In actual application, the foregoing functions may be allocated to different functional modules for implementation based on a requirement, for example, an internal structure of an apparatus is divided into different functional modules, to complete all or some of the functions described above.

In the several embodiments provided in this disclosure, it should be understood that the disclosed apparatus/device and method may be implemented in other manners. For example, the apparatus/device embodiments described above are merely examples. For example, division into modules or units is merely logical function division. In actual implementation, there may be another division manner. For example, a plurality of units or components may be combined or integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in an electrical form, a mechanical form, or another form.

The units described as separate parts may or may not be physically separate, and parts displayed as units may be one or more physical units, for example, may be located in one place, or may be distributed in a plurality of different places. Some or all of the units may be selected based on actual requirements to achieve the objectives of the solutions in the embodiments.

In addition, the functional units in the embodiments of this disclosure may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of the embodiments of this disclosure essentially, or the part contributing to the conventional technology, or all or some of the technical solutions may be implemented in a form of a software product. The software product is stored in a storage medium and includes several instructions for enabling a device (which may be a single-chip microcomputer, a chip, or the like) or a processor to perform all or some of the steps of the methods described in the embodiments of this disclosure. The foregoing storage medium includes various media that can store program code, for example, a USB flash drive, a removable hard disk, a read-only memory (read only memory, ROM), a random access memory (RAM), a magnetic disk, or an optical disc.

The foregoing content is merely specific implementations of this disclosure, but is not intended to limit the protection scope of this disclosure. Any variation or replacement made within the technical scope disclosed in this disclosure shall fall within the protection scope of this disclosure. Therefore, the protection scope of this disclosure shall be subject to the protection scope of the claims.

What is claimed is:

1. A layer composition method applied to an electronic device that comprises a graphics processing unit (GPU) and a hardware composer (HWC), the method comprising:
obtaining layer information of to-be-composited layers in a current frame;
determining a first detection result based on the layer information of the to-be-composited layers;
responsive to the first detection result not meeting a first condition and first target layers that meet a preset condition existing in the to-be-composited layers, controlling the GPU to composite the first target layers to obtain a first intermediate layer and controlling the HWC to query a composition manner of the to-be-composited layers,
wherein a composition manner of the first target layers that meet the preset condition is GPU composition, and
wherein the preset condition comprises any one or more of:
a layer attribute parameter or a display parameter of a layer changes;
a layer is a newly added layer, a layer attribute parameter comprises a first mark, and the first mark is used to indicate to use the GPU for composition;
a layer is a newly added layer, and a buffer size of the layer is greater than a preset size;
a composition manner of a layer in a previous frame is GPU composition and a position of the layer changes or a visible area of the layer becomes larger; or
a position of a layer is rotated 180° compared with that in a previous frame; and
responsive to composition manners of all second target layers being HWC composition, controlling the HWC to composite the first intermediate layer and the second target layers to obtain an image of the current frame,
wherein the second target layers are to-be-composited layers other than the first target layers in the to-be-composited layers.

2. The method of claim 1, wherein determining the first detection result based on the layer information of the to-be-composited layers comprises:
calculating, by the electronic device, a hash value of the current frame based on the layer information of the to-be-composited layers;
responsive to the hash value of the current frame being the same as a hash value of the previous frame, determining that the first detection result meets the first condition; and
responsive to the hash value of the current frame being different from the hash value of the previous frame, determining that the first detection result does not meet the first condition.

3. The method of claim 1, wherein after controlling the GPU to composite the first target layers to obtain the first intermediate layer and controlling the HWC to query the composition manner of the to-be-composited layers, the method further comprises:
responsive to a third target layer whose composition manner is GPU composition existing in the second target layers, controlling the GPU to composite the third target layer with the first intermediate layer to obtain an updated first intermediate layer, wherein the third target layer and the first target layer are different to-be-composited layers; and
controlling the HWC to composite the updated first intermediate layer and a to-be-composited layer other than the third target layer in the second target layers to obtain the image of the current frame.

4. The method of claim 1, further comprising:
responsive to the first detection result not meeting the first condition, no first target layer existing in the to-be-composited layers, and fourth target layers existing in the to-be-composited layers, controlling the GPU to composite the fourth target layers to obtain a second intermediate layer and controlling the HWC to query the composition manner of the to-be-composited layers, wherein a composition manner of the fourth target layers is GPU composition, and wherein a composition manner of the fourth target layers in the previous frame is GPU composition; and
responsive to composition manners of all fifth target layers being HWC composition, controlling the HWC to composite the second intermediate layer and the fifth target layers to obtain the image of the current frame, wherein the fifth target layers are to-be-composited layers other than the fourth target layers in the to-be-composited layers.

5. The method of claim 4, wherein after controlling the GPU to composite the fourth target layers to obtain the second intermediate layer and controlling the HWC to query the composition manner of the to-be-composited layers, the method further comprises:
responsive to a sixth target layer whose composition manner is GPU composition existing in the fifth target layers, controlling the GPU to composite the sixth target layer with the second intermediate layer to obtain an updated second intermediate layer, wherein the sixth target layer and the fourth target layer are different to-be-composited layers; and
controlling the HWC to composite the updated second intermediate layer and a to-be-composited layer other than the sixth target layer in the fifth target layers to obtain the image of the current frame.

6. The method of claim 1, wherein the layer information comprises an identifier of a buffer of the layer, a layer attribute parameter, and a display parameter, wherein the layer attribute parameter comprises any one or more of a blur parameter, transparency, a position, a size, a name, a type, or visibility, and wherein the display parameter comprises any one or more of a color, transparency, a blending mode, a depth sorting, a clipping parameter, or an occlusion parameter.

7. The method of claim 1, wherein the newly added layer is a layer that does not exist in the previous frame.

8. The method of claim 1, wherein before obtaining the layer information of to-be-composited layers in the current frame, the method further comprises:
receiving a first operation of a user;
initiating startup of a first application; and
obtaining the layer information of the to-be-composited layers in the current frame in a startup process of the first application.

9. An electronic device, comprising:
a display;
one or more processors coupled to the display; and
a memory coupled to the one or more processors and storing computer program code comprising computer instructions that when executed by the one or more processors, configures the electronic device for:
obtaining layer information of to-be-composited layers in a current frame;
determining a first detection result based on the layer information of the to-be-composited layers;
responsive to the first detection result not meeting a first condition and first target layers that meet a preset condition existing in the to-be-composited layers, controlling the GPU to composite the first target layers to obtain a first intermediate layer and controlling the HWC to query a composition manner of the to-be-composited layers,
wherein a composition manner of the first target layers that meet the preset condition is GPU composition, and
wherein the preset condition comprises any one or more of:
a layer is a newly added layer, and a buffer size of the layer is greater than a preset size;
a composition manner of a layer in a previous frame is GPU composition and a position of the layer changes or a visible area of the layer becomes larger; or
a position of a layer is rotated 180° compared with that in a previous frame;
and
responsive to composition manners of all second target layers being HWC composition, controlling the HWC to composite the first intermediate layer and the second target layers to obtain an image of the current frame,
wherein the second target layers are to-be-composited layers other than the first target layers in the to-be-composited layers.

10. The electronic device of claim 9, wherein determining the first detection result based on the layer information of the to-be-composited layers comprises:
calculating, by the electronic device, a hash value of the current frame based on the layer information of the to-be-composited layers;
responsive to the hash value of the current frame being the same as a hash value of the previous frame, determining that the first detection result meets the first condition; and
responsive to the hash value of the current frame being different from the hash value of the previous frame, determining that the first detection result does not meet the first condition.

11. The electronic device of claim 9, wherein after controlling the GPU to composite the first target layers to obtain the first intermediate layer and controlling the HWC to query the composition manner of the to-be-composited layers, the one or more processors executing the instructions further configures the electronic device for:
responsive to a third target layer whose composition manner is GPU composition existing in the second target layers, controlling the GPU to composite the third target layer with the first intermediate layer to obtain an updated first intermediate layer, wherein the third target layer and the first target layer are different to-be-composited layers; and
controlling the HWC to composite the updated first intermediate layer and a to-be-composited layer other than the third target layer in the second target layers to obtain the image of the current frame.

12. The electronic device of claim 9, wherein the one or more processors executing the instructions further configures the electronic device for:
responsive to the first detection result not meeting the first condition, no first target layer existing in the to-be-composited layers, and fourth target layers existing in the to-be-composited layers, controlling the GPU to composite the fourth target layers to obtain a second intermediate layer and controlling the HWC to query the composition manner of the to-be-composited layers, wherein a composition manner of the fourth target layers is GPU composition, and wherein a composition manner of the fourth target layers in the previous frame is GPU composition; and
responsive to composition manners of all fifth target layers being HWC composition, controlling the HWC to composite the second intermediate layer and the fifth target layers to obtain the image of the current frame, wherein the fifth target layers are to-be-composited layers other than the fourth target layers in the to-be-composited layers.

13. The electronic device of claim 12, wherein after controlling the GPU to composite the fourth target layers to obtain the second intermediate layer and controlling the HWC to query the composition manner of the to-be-composited layers, the one or more processors executing the instructions further configures the electronic device for:
responsive to a sixth target layer whose composition manner is GPU composition existing in the fifth target layers, controlling the GPU to composite the sixth target layer with the second intermediate layer to obtain an updated second intermediate layer, wherein the sixth target layer and the fourth target layer are different to-be-composited layers; and
controlling the HWC to composite the updated second intermediate layer and a to-be-composited layer other than the sixth target layer in the fifth target layers to obtain the image of the current frame.

14. The electronic device of claim 9, wherein the layer information comprises an identifier of a buffer of the layer, a layer attribute parameter, and a display parameter, wherein the layer attribute parameter comprises any one or more of a blur parameter, transparency, a position, a size, a name, a type, or visibility, and wherein the display parameter comprises any one or more of a color, transparency, a blending mode, a depth sorting, a clipping parameter, or an occlusion parameter.

15. The electronic device of claim 9, wherein the newly added layer is a layer that does not exist in the previous frame.

16. The electronic device of claim 9, wherein before obtaining the layer information of to-be-composited layers in the current frame, the one or more processors executing the instructions further configures the electronic device for:
receiving a first operation of a user;
initiating startup of a first application; and
obtaining the layer information of the to-be-composited layers in the current frame in a startup process of the first application.

17. A computer-readable storage medium comprising computer instructions that when run on an electronic device, configures the electronic device for:
obtaining layer information of to-be-composited layers in a current frame;
determining a first detection result based on the layer information of the to-be-composited layers;
responsive to the first detection result not meeting a first condition and first target layers that meet a preset condition existing in the to-be-composited layers, controlling the GPU to composite the first target layers to obtain a first intermediate layer and controlling the HWC to query a composition manner of the to-be-composited layers,
wherein a composition manner of the first target layers that meet the preset condition is GPU composition, and
wherein the preset condition comprises any one or more of:
a layer attribute parameter or a display parameter of a layer changes; or
a layer is a newly added layer, a layer attribute parameter comprises a first mark, and the first mark is used to indicate to use the GPU for composition;
and
responsive to composition manners of all second target layers being HWC composition, controlling the HWC to composite the first intermediate layer and the second target layers to obtain an image of the current frame,
wherein the second target layers are to-be-composited layers other than the first target layers in the to-be-composited layers.

18. The computer-readable storage medium of claim 17, wherein determining the first detection result based on the layer information of the to-be-composited layers comprises:
calculating, by the electronic device, a hash value of the current frame based on the layer information of the to-be-composited layers;
responsive to the hash value of the current frame being the same as a hash value of the previous frame, determining that the first detection result meets the first condition; and
responsive to the hash value of the current frame being different from the hash value of the previous frame, determining that the first detection result does not meet the first condition.

19. The computer-readable storage medium of claim 17, wherein after controlling the GPU to composite the first target layers to obtain the first intermediate layer and controlling the HWC to query the composition manner of the to-be-composited layers, running the computer instructions on the electronic device configures the electronic device for:
responsive to a third target layer whose composition manner is GPU composition existing in the second target layers, controlling the GPU to composite the third target layer with the first intermediate layer to obtain an updated first intermediate layer, wherein the third target layer and the first target layer are different to-be-composited layers; and
controlling the HWC to composite the updated first intermediate layer and a to-be-composited layer other than the third target layer in the second target layers to obtain the image of the current frame.

20. The computer-readable storage medium of claim 17, wherein running the computer instructions on the electronic device configures the electronic device for:
responsive to the first detection result not meeting the first condition, no first target layer existing in the to-be-composited layers, and fourth target layers existing in the to-be-composited layers, controlling the GPU to composite the fourth target layers to obtain a second intermediate layer and controlling the HWC to query the composition manner of the to-be-composited layers, wherein a composition manner of the fourth target layers is GPU composition, and wherein a composition manner of the fourth target layers in the previous frame is GPU composition; and
responsive to composition manners of all fifth target layers being HWC composition, controlling the HWC to composite the second intermediate layer and the fifth target layers to obtain the image of the current frame, wherein the fifth target layers are to-be-composited layers other than the fourth target layers in the to-be-composited layers.
